(19) United States
(12) Patent Application Publication
(10) Pub. No.: US 2013/0100305 A1
(43) Pub. Date: Apr. 25, 2013

(54) IMAGING LENS AND IMAGING DEVICE

(71) Applicant: Sony Corporation, Tokyo (JP)

(72) Inventors: Naoki Miyagawa, Kanagawa (JP); Hiroyuki Matsumoto, Tokyo (JP)

(73) Assignee: Sony Corporation, Tokyo (JP)

(21) Appl. No.: 13/653,023

(22) Filed: Oct. 16, 2012

(30) Foreign Application Priority Data
Oct. 20, 2011 (JP) 2011-230923

(51) Int. Cl. G02B 27/64; H04N 5/232

(52) U.S. Cl. CPC G02B 27/64; H04N 5/23264
USPC 348/208.11; 359/557

(57) ABSTRACT

An imaging lens includes an aperture stop, a front group arranged to the object side, and a rear group arranged to the image side, wherein image blurring correction on an image face is performed by including a lens with a positive refractive force and moving the lens with the positive refractive force as a blurring correction lens in a different direction from the optical axis. The rear group includes a lens group GrA with a positive refractive force and a lens group GrB with a negative refractive force. The blurring correction lens, the lens group GrA, and the lens group GrB respectively include one or two lenses.

### BACKGROUND

The present disclosure relates to an imaging lens system used in an interchangeable lens type device or the like of a so-called interchangeable lens digital camera. In detail, the present disclosure relates to a high-performance inner focus type imaging lens with an intermediate telescopic range capturing angle with a large aperture ratio including a so-called camera shake correction function for correcting for image blurring of a captured image due to camera shake, and an imaging device in which such an imaging lens is built in.

Generally with a capturing lens, the entire capturing lens system is moved when focusing or a lens group of a portion of the capturing lens is moved. In the case of large aperture ratio capturing lenses with intermediate telescopic range angles from the standard, while many are configured as a Gauss type or a modified type thereof, and almost all are types that draw out the entire lens system, the lens described in Japanese Unexamined Patent Application Publication No. 64-78208 is exemplified as an example of moving only a Gauss type rear group.

The optical systems described in Japanese Unexamined Patent Application Publication No. 2003-43348 and Japanese Unexamined Patent Application Publication No. 2008-145584 and the like are exemplified as inner focus type lenses with an intermediate telescopic to telescopic range capturing angle in an interchangeable lens camera system, with a large aperture ratio including a camera shake correction function for correcting for image blurring due to camera shake. The optical system described in Japanese Unexamined Patent Application Publication No. 2003-43348 is configured by three groups with positive, negative, and positive refractive forces in order from the object side, and performs camera shake correction by performing focusing with the second lens group and moving a portion of the lens groups with a positive refractive force among the third lens group in a direction that is substantially perpendicular to the optical axis. The optical system described in Japanese Unexamined Patent Application Publication No. 2008-145584 is configured by three groups with positive, negative, and positive refractive forces, and performs camera shake correction by performing focusing with the second lens group and moving a portion of the lens groups with a negative refractive force among the third lens group in a direction that is substantially perpendicular to the optical axis.

Further, an optical system with a configuration including first to third focus lens groups and in which camera shake correction lens groups are arranged further to the image side from the first focus lens group is described in Japanese Unexamined Patent Application Publication No. 2011-48232.

### SUMMARY

In recent years, interchangeable lens type digital cameras have been rapidly gaining popularity. In particular, since moving image capturing is now possible with interchangeable lens type camera systems, lenses that are suited not only to still image but also to moving images are in demand. When capturing a moving image, in order to follow the rapid movement of the subject, it is important to move a lens group that performs focusing at high speed. Further, even with a lens with an intermediate telescopic range capturing angle, there is demand for a camera shake correction mechanism to perform image blurring correction of the captured image due to camera shake or the like. Further, even with regard to a lens with a large aperture ratio and an intermediate telescopic range imaging angle, there is demand for high-speed focusing in order to be compatible with moving image capturing.

A Gauss type lens is proposed in Japanese Unexamined Patent Application Publication No. 64-78208. During the focusing, the entire rear group interposing aperture stop moves in the optical axis direction. When focusing is to be performed while moving the entire lens system or the entire rear group at high speed for moving image capturing, since the mass of the focus lens group is large, there is a problem in that the actuator for moving the lens is enlarged, and the lens barrel is enlarged.

The optical system proposed in Japanese Unexamined Patent Application Publication No. 2003-43348 includes, in order from the object side, a first lens group with a positive refractive force, a second lens group with a negative refractive force, and a third lens group with a positive refractive force, and the second lens group moves in the optical axis direction when focusing. However, when high-speed focusing for moving image capturing is to be performed, since the second lens group is configured by a plurality of lenses and the mass is large, the driving actuator is enlarged and the lens barrel size is enlarged. Further, since the lens group with the positive refractive force among the third lens group performing camera shake correction is configured by a plurality of lenses and the mass is large, and the lens group is also arranged furthest to the image side of the optical system, the diameter is enlarged. Therefore, there is a problem in that the actuator for driving the camera shake correction lens group in a direction that is substantially perpendicular to the optical axis and the lens barrel are enlarged.

The optical system proposed in Japanese Unexamined Patent Application Publication No. 2008-145584 includes, in order from the object side, a first lens group with a positive refractive force, a second lens group with a negative refractive force, and a third lens group with a positive refractive force, and the second lens group moves in the optical axis direction when focusing. However, when high-speed focusing for moving image capturing is to be performed, since the second lens group is configured by a plurality of lenses and the mass is large, the driving actuator is enlarged and the lens barrel size is enlarged. Further, since the lens group with the positive refractive force among the third lens group performing camera shake correction is configured by a plurality of lenses and the mass is large, there is a problem in that the actuator for driving the lens in a direction that is substantially perpendicular to the optical axis and the lens barrel are enlarged.

With the optical system proposed in Japanese Unexamined Patent Application Publication No. 2011-48232, since it is important to move three focus lens groups when focusing, the driving mechanism and driving control are made complex, and the cost also rises.

It is desirable to provide an imaging lens with which compact and high-speed focusing is possible and correction of image blurring of the captured image due to camera shake or the like is possible with a high imaging performance, and an imaging device.

An imaging lens according to an embodiment of the present disclosure includes: an aperture stop; a front group arranged further to the object side than the aperture stop; and a rear group arranged further to the image side than the aperture stop, wherein image blurring correction on an image face is performed by including a lens with a positive refractive force within the front group or the rear group next to the aperture stop and moving the lens with the positive refractive force as a blurring correction lens in a different direction from the optical axis, the rear group includes a lens group GrA with a positive refractive force arranged next to the blurring correction lens on the image side and a lens group GrB with a negative refractive force arranged next to the lens group GrA on the image side, the blurring correction lens, the lens group GrA, and the lens group GrB are respectively configured by one or two lenses, focusing is performed by moving the lens group GrA or the lens group GrB as a focus lens group in the optical axis direction, and each of the following conditional equations are satisfied.

−1.0<f/f1a<0.5 (1)

(βf+1/βf)⁻²<0.16 (2)

wherein

f: focus distance of the entire system

f1a: focus distance of a lens group further to the object side than the blurring correction lens

βf: lateral magnification of the focus lens group.

An imaging device according to another embodiment of the present disclosure includes: an imaging lens; and an imaging element formed of the imaging lens outputting an imaging signal according to an optical image, wherein the imaging lens is configured by the imaging lens according to the embodiment of the present disclosure described above.

With the imaging lens or the imaging device according to the embodiments of the present disclosure, image blurring correction on an image face is performed by including a lens with a positive refractive force within the front group or the rear group next to the aperture stop and moving the lens with the positive refractive force as the blurring correction lens in a different direction from the optical axis. Further, focusing is performed by moving the lens group GrA or the lens group GrB within the rear group as a focus lens group in the optical axis direction.

According to the imaging lens or the imaging device of the embodiments of the present disclosure, with a configuration in which the front group and the rear group are arranged to interpose the aperture stop, since the configuration of each lens group is optimized by the lens with a positive refractive force next to the aperture stop as the blurring correction lens and a portion of the lens group within the rear group as the focus lens group, compact yet high-speed focusing is possible, image blurring correction of the captured image due to camera shake or the like is able to be performed, and a high imaging performance is able to be realized.

### BRIEF DESCRIPTION OF THE DRAWINGS

FIG. 1 illustrates a first configuration of an imaging lens according to an embodiment of the present disclosure, and is a lens cross-sectional view corresponding to Numerical Example 1;

FIG. 2 illustrates a second configuration example of the imaging lens, and is a lens cross-sectional view corresponding to Numerical Example 2;

FIG. 3 illustrates a third configuration example of the imaging lens, and is a lens cross-sectional view corresponding to Numerical Example 3;

FIG. 4 illustrates a fourth configuration example of the imaging lens, and is a lens cross-sectional view corresponding to Numerical Example 4;

FIG. 5 illustrates a fifth configuration example of the imaging lens, and is a lens cross-sectional view corresponding to Numerical Example 5;

FIG. 6 illustrates a sixth configuration example of the imaging lens, and is a lens cross-sectional view corresponding to Numerical Example 6;

FIG. 7 illustrates a seventh configuration example of the imaging lens, and is a lens cross-sectional view corresponding to Numerical Example 7;

FIG. 8 illustrates an eighth configuration example of the imaging lens, and is a lens cross-sectional view corresponding to Numerical Example 8;

FIGS. 9A to 9C are aberration views that illustrate the longitudinal aberration of the imaging lens corresponding to Numerical Example 1 during unlimited focusing, and FIG. 9A illustrates the spherical surface aberration, FIG. 9B illustrates the astigmatism, and FIG. 9C illustrates the distortion;

FIGS. 10A to 10C are aberration views that illustrate the longitudinal aberration of the imaging lens corresponding to Numerical Example 1 during limited distance focusing (β=−0.025), and FIG. 10A illustrates the spherical surface aberration, FIG. 10B illustrates the astigmatism, and FIG. 10C illustrates the distortion;

FIGS. 11A to 11C are aberration views that illustrate the longitudinal aberration of the imaging lens corresponding to Numerical Example 2 during unlimited focusing, and FIG. 11A illustrates the spherical surface aberration, FIG. 11B illustrates the astigmatism, and FIG. 11C illustrates the distortion;

FIGS. 12A to 12C are aberration views that illustrate the longitudinal aberration of the imaging lens corresponding to Numerical Example 2 during limited distance focusing (β=−0.025), and FIG. 12A illustrates the spherical surface aberration, FIG. 12B illustrates the astigmatism, and FIG. 12C illustrates the distortion;

FIGS. 13A to 13C are aberration views that illustrate the longitudinal aberration of the imaging lens corresponding to Numerical Example 3 during unlimited focusing, and FIG. 13A illustrates the spherical surface aberration, FIG. 13B illustrates the astigmatism, and FIG. 13C illustrates the distortion;

FIGS. 14A to 14C are aberration views that illustrate the longitudinal aberration of the imaging lens corresponding to Numerical Example 3 during limited distance focusing (β=−0.025), and FIG. 14A illustrates the spherical surface aberration, FIG. 14B illustrates the astigmatism, and FIG. 14C illustrates the distortion;

FIGS. 15A to 15C are aberration views that illustrate the longitudinal aberration of the imaging lens corresponding to Numerical Example 4 during unlimited focusing, and FIG. 13A illustrates the spherical surface aberration, FIG. 15B illustrates the astigmatism, and FIG. 15C illustrates the distortion;

FIGS. 16A to 16C are aberration views that illustrate the longitudinal aberration of the imaging lens corresponding to Numerical Example 4 during limited distance focusing (β=−0.025), and FIG. 16A illustrates the spherical surface aberration, FIG. 16B illustrates the astigmatism, and FIG. 16C illustrates the distortion;

FIGS. 17A to 17C are aberration views that illustrate the longitudinal aberration of the imaging lens corresponding to Numerical Example 5 during unlimited focusing, and FIG. 17A illustrates the spherical surface aberration, FIG. 17B illustrates the astigmatism, and FIG. 17C illustrates the distortion;

FIGS. 18A to 18C are aberration views that illustrate the longitudinal aberration of the imaging lens corresponding to Numerical Example 5 during limited distance focusing (β=−0.025), and FIG. 18A illustrates the spherical surface aberration, FIG. 18B illustrates the astigmatism, and FIG. 18C illustrates the distortion;

FIGS. 19A to 19C are aberration views that illustrate the longitudinal aberration of the imaging lens corresponding to Numerical Example 6 during unlimited focusing, and FIG. 19A illustrates the spherical surface aberration, FIG. 19B illustrates the astigmatism, and FIG. 19C illustrates the distortion;

FIGS. 20A to 20C are aberration views that illustrate the longitudinal aberration of the imaging lens corresponding to Numerical Example 6 during limited distance focusing (β=−0.025), and FIG. 20A illustrates the spherical surface aberration, FIG. 20B illustrates the astigmatism, and FIG. 20C illustrates the distortion;

FIGS. 21A to 21C are aberration views that illustrate the longitudinal aberration of the imaging lens corresponding to Numerical Example 7 during unlimited focusing, and FIG. 21A illustrates the spherical surface aberration, FIG. 21B illustrates the astigmatism, and FIG. 21C illustrates the distortion;

FIGS. 22A to 22C are aberration views that illustrate the longitudinal aberration of the imaging lens corresponding to Numerical Example 7 during limited distance focusing (β=−0.025), and FIG. 22A illustrates the spherical surface aberration, FIG. 22B illustrates the astigmatism, and FIG. 22C illustrates the distortion;

FIGS. 23A to 23C are aberration views that illustrate the longitudinal aberration of the imaging lens corresponding to Numerical Example 8 during unlimited focusing, and FIG. 23A illustrates the spherical surface aberration, FIG. 23B illustrates the astigmatism, and FIG. 23C illustrates the distortion;

FIGS. 24A to 24C are aberration views that illustrate the longitudinal aberration of the imaging lens corresponding to Numerical Example 8 during limited distance focusing (β=−0.025), and FIG. 24A illustrates the spherical surface aberration, FIG. 24B illustrates the astigmatism, and FIG. 24C illustrates the distortion;

FIGS. 25A to 25C are aberration views that illustrate the lateral aberration of the imaging lens corresponding to Numerical Example 1 during unlimited focusing, and FIG. 25A illustrates the lateral aberration before image blurring correction, FIG. 25B illustrates the lateral aberration after image blurring correction with an image angle of +0.3°, and FIG. 25C illustrates the lateral aberration after image blurring correction with an image angle of −0.3°;

FIGS. 26A to 26C are aberration views that illustrate the lateral aberration of the imaging lens corresponding to Numerical Example 2 during unlimited focusing, and FIG. 26A illustrates the lateral aberration before image blurring correction, FIG. 26B illustrates the lateral aberration after image blurring correction with an image angle of +0.3°, and FIG. 26C illustrates the lateral aberration after image blurring correction with an image angle of −0.3°;

FIGS. 27A to 27C are aberration views that illustrate the lateral aberration of the imaging lens corresponding to Numerical Example 3 during unlimited focusing, and FIG. 27A illustrates the lateral aberration before image blurring correction, FIG. 27B illustrates the lateral aberration after image blurring correction with an image angle of +0.3°, and FIG. 27C illustrates the lateral aberration after image blurring correction with an image angle of −0.3°;

FIGS. 28A to 28C are aberration views that illustrate the lateral aberration of the imaging lens corresponding to Numerical Example 4 during unlimited focusing, and FIG. 28A illustrates the lateral aberration before image blurring correction, FIG. 28B illustrates the lateral aberration after image blurring correction with an image angle of +0.3°, and FIG. 28C illustrates the lateral aberration after image blurring correction with an image angle of −0.3°;

FIGS. 29A to 29C are aberration views that illustrate the lateral aberration of the imaging lens corresponding to Numerical Example 5 during unlimited focusing, and FIG. 29A illustrates the lateral aberration before image blurring correction, FIG. 29B illustrates the lateral aberration after image blurring correction with an image angle of +0.3°, and FIG. 29C illustrates the lateral aberration after image blurring correction with an image angle of −0.3°;

FIGS. 30A to 30C are aberration views that illustrate the lateral aberration of the imaging lens corresponding to Numerical Example 6 during unlimited focusing, and FIG. 30A illustrates the lateral aberration before image blurring correction, FIG. 30B illustrates the lateral aberration after image blurring correction with an image angle of +0.3°, and FIG. 30C illustrates the lateral aberration after image blurring correction with an image angle of −0.3°;

FIGS. 31A to 31C are aberration views that illustrate the lateral aberration of the imaging lens corresponding to Numerical Example 7 during unlimited focusing, and FIG. 31A illustrates the lateral aberration before image blurring correction, FIG. 31B illustrates the lateral aberration after image blurring correction with an image angle of +0.3°, and FIG. 31C illustrates the lateral aberration after image blurring correction with an image angle of −0.3°;

FIGS. 32A to 32C are aberration views that illustrate the lateral aberration of the imaging lens corresponding to Numerical Example 8 during unlimited focusing, and FIG. 32A illustrates the lateral aberration before image blurring correction, FIG. 32B illustrates the lateral aberration after image blurring correction with an image angle of +0.3°, and FIG. 32C illustrates the lateral aberration after image blurring correction with an image angle of −0.3°; and

FIG. 33 is a block diagram that illustrates a configuration example of an imaging device.

### DETAILED DESCRIPTION OF EMBODIMENTS

Here, embodiments of the present disclosure will be described in detail below with reference to the drawings.

### Basic Configuration of Lens

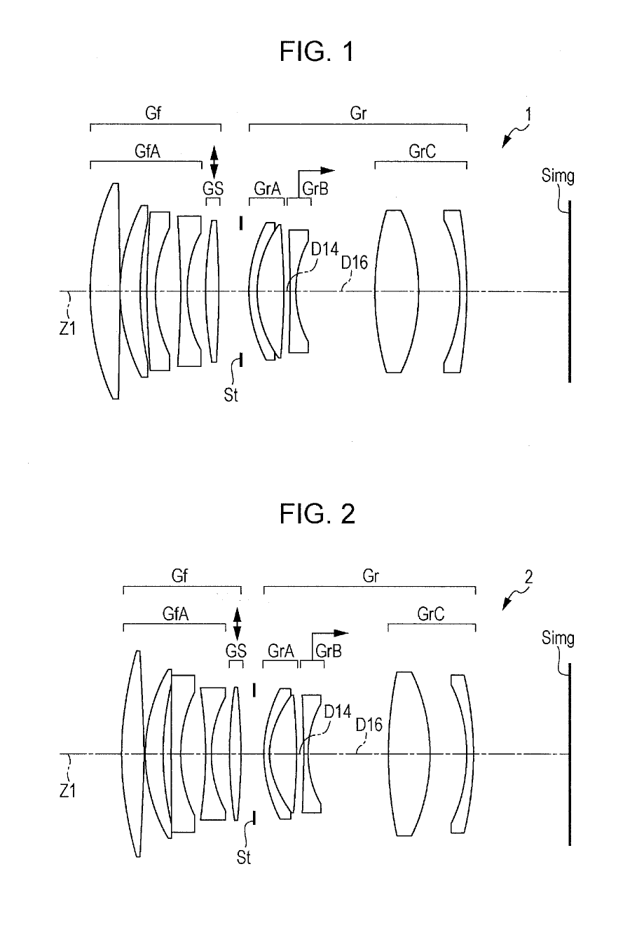

FIG. 1 illustrates a first configuration example of an imaging lens according to an embodiment of the present disclosure. The configuration example corresponds to the lens configuration of Numerical Example 1 described later. Here, FIG. 1 corresponds to a lens arrangement during unlimited focusing. Similarly, the cross-sectional configurations of the second to eighth configuration examples corresponding to the lens configurations of Numerical Examples 2 to 8 described later are illustrated in FIGS. 2 to 8. In FIGS. 1 to 8, the symbol Simg indicates the image face. The symbol Di indicates the surface interval between an ith face and an i+1st face on an optical axis Z1. Here, the symbol Di is only given to the surface interval of portions that change along with the focusing (for example, in FIGS. 1, D14 and D16).

An imaging lens according to the present embodiment is configured by an aperture stop St, a front group Gf arranged further to the object side than the aperture stop St, and a rear group Gr arranged further to the image side than the aperture stop St.

The imaging lens according to the present embodiment performs image blurring correction on the image face by including a lens with a positive refractive force next to the aperture stop St within the front group Gf or the rear group Gr and moving the lens with the positive refractive force as a blurring correction lens GS in a different direction from the optical axis (substantially vertical direction). As a specific configuration example, with an imaging lens 7 according to the seventh configuration example, a lens with a positive refractive force is included in the rear group Gr next to the aperture stop St, and the lens with the positive refractive force is the blurring correction lens GS. With imaging lenses 1 to 6 and 8 according to configuration examples other than the seventh configuration example, a lens with a positive refractive force is included within the front group Gf next to the aperture stop St, and the lens with the positive refractive force is the blurring correction lens GS.

The rear group Gr includes a lens group GrA with a positive refractive force arranged next to the blurring correction lens GS on the image side and a lens group GrB with a negative refractive force arranged next to the lens group GrA on the image side. Focusing is performed by moving the lens group GrA or the lens group GrB as a focus lens group in the optical axis direction. As specific configuration examples, with the imaging lenses 1 to 6 according to the first to sixth configuration examples, the lens group GrB is the focus lens group, and when performing focusing from an unlimited to a limited distance, the lens group GrB moves to the image side as illustrated in the drawings. With the imaging lenses 7 and 8 according to the seventh and eighth configuration examples, the lens group GrA is the focus lens group, and when performing focusing from an unlimited to a limited distance, the lens group GrA moves to the object side as illustrated in the drawings.

The blurring correction lens GS, the lens group GrA, and the lens group GrB are respectively configured by one or two lenses. It is preferable that the lens group GrA be formed of a cemented lens of a negative lens and a positive lens. As specific configuration examples, with any of the imaging lenses 1 to 3 and 5 to 8 according to the configuration examples other than the fourth configuration example, the lens group GrA is configured in such a manner.

It is preferable that the rear group Gr further include a lens group GrC with a positive refractive force arranged to the image side of the lens group GrB. It is preferable that the lens group GrC be formed of one positive lens and one negative lens. As specific configuration examples, with any of the imaging lenses 1 to 5 and 7 and 8 according to the configuration examples other than the sixth configuration example, the lens group GrC is configured in such a manner.

Otherwise, it is preferable that the imaging lens according to the present embodiment satisfy predetermined conditional equations described later.

### Operation and Effects

Next, the operation and effects of the imaging lens according to the present embodiment will be described.

With the imaging lens according to the present embodiment, image blurring correction on the image face is performed by including a lens with a positive refractive force next to the aperture stop St within the front group Gf or the rear group Gr and moving the lens with the positive refractive force as the blurring correction lens GS in a different direction to the optical axis Z1 (substantially perpendicular direction). Further, focusing is performed by moving the lens group GrA or the lens group GrB within the rear group as the focus lens group in the optical axis direction. In such a manner, in a configuration in which the front group Gf and the rear group Gr are arranged interposing to aperture stop St, since the configuration of each lens group is optimized with the lens with the positive refractive force next to the aperture stop St as the blurring correction lens GS and a portion of the lens group within the rear group Gr as the focus lens group, compact yet high-speed focusing is possible, image blurring correction of the captured image due to camera shake or the like is able to be performed, and a high imaging performance is able to be realized.

### Operations of Blurring Correction Lens GS and Focus Lens Group

With the imaging lens according to the present embodiment, the blurring correction lens GS is arranged near the center of the optical system and since the outer form of the blurring correction lens GS is small, the mass is small, and the blurring correction lens GS is able to be moved at high speed by a compact actuator. Further, since the blurring correction lens GS is arranged near the center of the optical system, the off-axis luminous flux does not separate from the on-axis luminous flux and is not transmitted, which is advantageous for aberration correction.

Generally, when the optical system is shifted in a direction that is perpendicular to the optical axis, the movement amount δ of the image on the image face when the magnification of the shift lens is βs, the shift amount is Δ, and the lateral magnification of the optical system further to the image side than the shift lens is βb, is able to be represented by

δ=(1−βs)×βb×Δ.

Accordingly, in order to reduce the shift amount Δ of the shift lens, it is important to increase the value of (1−βs)×βb.

On the other hand, if the focus distance of the optical system further to the object side than the shift lens is fa, the focus distance f of the entire optical system is able to be represented by

f=fa×βs×βb.

That is, in a case where fa is determined to an extent, βs×βb is a fixed value. At this time, in order to increase the value of (1−βs)×βb, it is clear that the absolute value of βs may be increased or may be selected to be close to 0.

Therefore, in the present embodiment, the value of βs described above is controlled by making the light beams in front of and behind the blurring correction lens GS approximately afocal, and when the blurring correction lens GS moves in a direction that is substantially perpendicular to the optical axis Z1, the ratio of the change amount of the image face position with respect to the movement amount of the blurring correction lens GS is able to be increased. Since it is then possible shorten the stroke of the blurring correction lens GS, the lens barrel is able to be miniaturized.

Since the lens group GrA or the lens group GrB out of the rear group Gr performing focusing is arranged near the center of the optical system and the outer form of the lens is small, the mass is small, and the lens is able to be moved at high speed by a compact actuator. Accordingly, by using the lens group GrA or the lens group GrB as the focus lens group, the focus lens group is able to be moved at high speed while maintaining the lens barrel size to be compact.

Generally, a ratio k between the movement amount of the focus lens group and the movement amount of the focus position on the image face when the lateral magnification of the focus lens group is βf and the lateral magnification of an optical system further to the image side than the focus lens group is βr is able to be represented by

K=(1−βf²)×βb².

Similarly to the shift lens described above, in order to increase k, the absolute value of βt may be increased or may be selected to be close to 0.

In the present embodiment, the light beams in front of and behind the lens group GrA or the lens group GrB as the focus lens group are approximately afocal, and the ratio (focus sensitivity) of the change amount of the image face position with respect to the movement amount of the lens group when the focus lens group is moved in the optical axis direction is able to be increased. Since the focus stroke is thereby able to be shortened, the total length of the lens is able to be shortened.

### Operations of Other Configuration Portions

According to the present embodiment, it is desirable that the lens group GrA be configured by a cemented lens of a negative lens and a positive lens. Through such a configuration, the on-axis color aberration is able to be corrected favorably.

Further, it is desirable that the lens group GrC with a positive refractive force be configured in order from the object side by one positive lens and one negative lens. Through such a configuration, the off-axis aberration, in particular the distortion and the field curvature, are able to be corrected favorably.

### Description of Conditional Equations

It is desirable that the imaging lens according to the present embodiments satisfy the following Conditional Equations 1 and 2.

−1.0<f/f1a<0.5 (1)

(βf+1/βf)⁻²<0.16 (2)

wherein

f: focus distance of the entire system

f1a: focus distance of a lens group GfA further to the object side than the blurring correction lens GS

βf: lateral magnification of the focus lens group.

Conditional Equation 1 regulates the ratio of a focus distance f1a of a lens group GfA further to the object side than the blurring correction lens with respect to a focus distance f of the entire lens system. If the range of Conditional Equation 1 is exceeded, since the F value of the lens group is the lens group further to the object side than the blurring correction lens GS increases, the configuration for correcting the generated aberration is made complex, or there may be a deterioration in performance when there is camera shake, and the lens shift amount during blurring correction increases.

Conditional Equation 2 regulates the lateral magnification of the focus lens group. If the range of Conditional Equation 2 is exceeded, since the focus sensitivity decreases, the focus stroke is increased, and the total length of the lens is increased.

By satisfying Conditional Equations 1 and 2 at the same time, the lens shift amount during blurring correction is able to be suppressed to be small while suppressing the optical system from becoming complex, the focus stroke is able to be shortened, and miniaturization of the lens barrel is possible.

Here, according to the present embodiment, it is preferable that the numerical ranges of Conditional Equations 1 and 2 described above be set in accordance with the following Conditional Equations 1′ and 2′.

−0.9<f/f1a<0.4 1′

(βf+1/βf)⁻²<0.12 2′

Furthermore, it is more preferable that the numerical ranges of Conditional Equations 1 and 2 described above be set in accordance with the following Conditional Equations 1″ and 2″.

−0.8<f/f1a<0.3 1″

(βf+1/βf)⁻²<0.08 2″

Furthermore, with the imaging lens according to the present embodiment, a more favorable performance is able to be obtained by optimizing the configuration of each lens by combining and satisfying at least one and preferably two or more of the following conditional equations.

It is desirable that the imaging lens according to the present embodiment satisfy the following Conditional Equations 3.

0.5<fS/f<2 3

wherein
fS: focus distance of the blurring correction lens GS

Conditional Equation 3 regulates the ratio of the focus distance fS of the blurring correction lens GS with respect to the focus distance f of the entire lens system. If the lower limit of Conditional Equation 3 is exceeded, the power of the blurring correction lens GS is too strong and the spherical aberration and the sine conditions of the blurring correction lens GS alone deteriorates, leading to deterioration in the on-axis and off-axis comatic aberration during camera shake. Further, the Petzval sum of the blurring correction lens GS alone increases and the image face change during camera shake increases, which is not preferable. If the upper limit of Conditional Equation 3 is exceeded, the spherical aberration occurring at the lens group GfA further to the object side than the blurring correction lens GS increases, which is not preferable.

Here, according to the present embodiment, it is preferable that the numerical range of Conditional Equation 3 be set in accordance with the following Conditional Equation 3′.

0.7<fS/f<1.9 3′

Furthermore, it is more preferable that the numerical range of Conditional Equation 3 described above be set in accordance with the following Conditional Equation 3′″. By setting the numerical range to that of Conditional Equation 3′″, it is possible to further suppress the lens shift amount during blurring correction to be small, and even as the blurring correction lens GS has a simple configuration, high optical performance is able to be maintained during camera shake.

0.8<fS/f<1.8 3″

It is desirable that the imaging lens according to the present embodiment satisfy the following Conditional Equation 4.

0.2<rGrB/f<0.9 4

wherein

rGrB: curvature radius of the face of the lens group

GrB furthest to the image side.

Conditional Equation 4 regulates the ratio of the focus distance f of the entire lens system with respect to the curvature radius rGrB of the face of the lens group GrB furthest to the image side. If the upper limit of Conditional Equation 4 is exceeded, the overall length is lengthened in order to correct the off-axis aberration. If the lower limit of Conditional Equation 4 is exceeded, the spherical surface aberration and the off-axis aberration occurring on the lens group GrB, particularly the distortion and the image face curvature, increase.

Here, according to the present embodiment, it is preferable that the numerical range of Conditional Equation 4 described above be set in accordance with the following Conditional Equation 4′.

0.25<rGrB/f<0.7 4′

Furthermore, according to the present embodiment, it is more preferable that the numerical range of Conditional Equation 4 described above be set in accordance with the following Conditional Equation 4″. By setting the numerical range to that of Conditional Expression 4″, the overall length of the lens is able to be shortened while favorably correcting the various aberrations.

0.3<rGrB/f<0.6 4″

It is desirable that the imaging lens according to the present embodiment satisfy the following Conditional Equation 5.

30.5<υdS 5

wherein

υdS: Abbe number with respect to the d line of the medium of the blurring lens correction lens GS.

Conditional Equation 5 regulates the Abbe number with respect to the d line (wavelength 587.6 nm) of the medium of the blurring correction lens GS. If Conditional Equation 5 is not reached, the color aberration occurring by the blurring correction lens GS alone increases, and the change in the magnification color aberration during camera shake increases.

### Application Example on Imaging Device

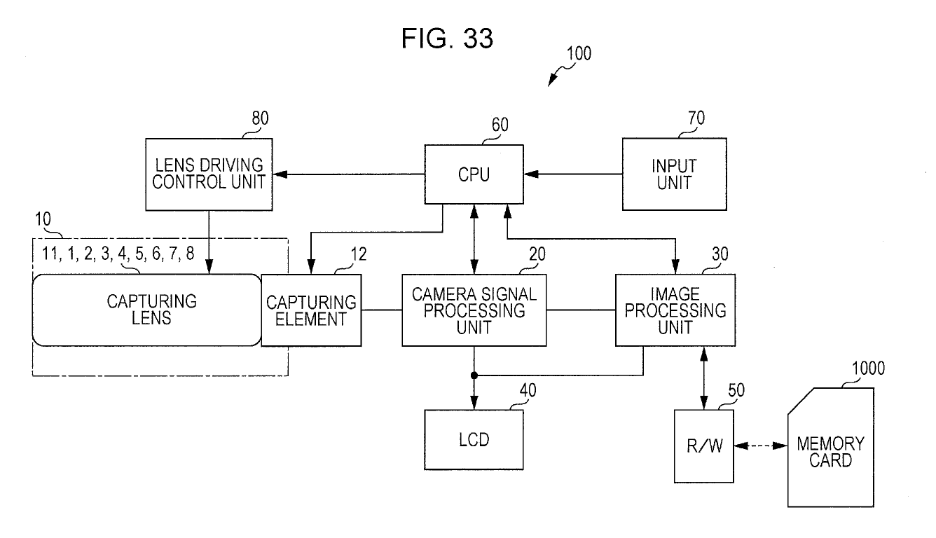

FIG. 33 illustrates a configuration example of an imaging device 100 to which the imaging lens according to the present embodiment is applied. The imaging device 100 is a digital still camera, for example, and includes a camera block 10, a camera signal processing unit 20, an image processing unit 30, an LCD (Liquid Crystal Display) 40, an R/W (reader/writer) 50, a CPU (Central Processing Unit) 60, and an input unit 70.

The camera block 10 carries an imaging function, and includes an optical system including an imaging lens 11 (imaging lens 1, 2, 3, 4, 5, 6, 7, or 8 illustrated in FIGS. 1 to 8) and an imaging element 12 such as a CCD (Charge Coupled Device) or a CMOS (Complementary Metal Oxide Semiconductor). The imaging element 12 outputs an imaging signal (image signal) according to an optical image by converting an optical image formed by the imaging lens 11 into an electrical signal.

The camera signal processing unit 20 performs various signal processes on the image signal output from the imaging element 12 such as analog-digital conversion, noise removal, image quality correction, and conversion to a brightness and color difference signal. As image quality correction, for example, a distortion correction process is performed on the captured image.

The image processing unit 30 performs a recording reproduction process of the image signal, and performs a compression encoding and decompression decoding process of the image signal based on a predetermined image data format, a conversion process of data such as the resolution, and the like.

The LCD 40 has a function of displaying various pieces of data such as the operation state of the user with respect to the input unit 70 and the captured image. The R/W 50 performs writing of the image data encoded by the image processing unit 30 into a memory card 1000 and reading of the image data recorded on the memory card 1000. The memory card 1000 is, for example, a semiconductor memory that is detachable with respect to a slot connected to the R/W 50.

The CPU 60 functions as a control processing unit controlling each circuit block provided on the imaging device 100, and controls each circuit block based on an instruction input signal or the like from the input unit 70. The input unit 70 is formed of various switches and the like on which important operations are performed by the user, and is configured by, for example, a shutter release button for performing a shutter operation, selection switches for selecting the operation mode, and the like, and outputs an instruction input signal according to the operation by the user to the CPU 60. A lens driving control unit 80 controls the driving of the lenses arranged on the camera block 10, and controls a motor and the like (not shown) that drives each lens of the imaging lens 11 based on a control signal from the CPU 60.

Although not shown in the drawings, the imaging device 100 includes a blurring detection unit detecting blurring of the device due to camera shake.

The operations of the imaging device 100 will be described below.

In a capturing standby state, an image signal captured by the camera block 10 is output to the LCD 40 via the camera signal processing unit 20 under the control of the CPU 60 and is displayed as a camera through image. Further, for example, when an instruction input signal for focusing is input from the input unit 70, the CPU 60 outputs a control signal to the lens driving control unit 80 and a predetermined lens of the imaging lens 11 is moved based on a control by the lens driving control unit 80.

When a shutter (not shown) of the camera block 10 is operated by an instruction input signal from the input unit 70, the captured image signal is output from the camera signal processing unit 20 to the image processing unit 30 and compression encoding processed, and is converted into digital data of a predetermined data format. The converted data is output to the R/W 50 and written into the memory card 1000.

Here, focusing is performed, for example, by the lens driving control unit 80 moving a predetermined lens of the imaging lens 11 based on a control signal from the CPU 60 in a case where the shutter release button of the input unit 50 is half pressed, in a case where the shutter release button is fully pressed for recording (capturing), or the like.

In a case where image data recorded on the memory card 1000 is to be reproduced, predetermined image data is read by the R/W 50 from the memory card 1000 according to an operation on the input unit 70 and a decompression decoding process is performed by the image processing unit 30, after which a reproduction image signal is output to the LCD 40 and a reproduction image is displayed.

Further, the CPU 60 operates the lens driving unit 80 based on a signal output from the blurring detection unit (not shown), and moves the blurring correction lens GS according to the blurring amount in a direction that is substantially perpendicular to the optical axis Z1.

Here, although an example in which the imaging device is applied to a digital still camera has been shown in the embodiment described above, the application range of the imaging device is not limited to a digital still camera, and various other electronic apparatuses may be specific targets of the imaging device 100. For example, various other electronic apparatuses such as an interchangeable lens type camera, a digital video camera, a mobile camera in which a digital video camera is built in, and a PDA (Personal Digital Assistant) may be specific targets of the imaging device 100.

### EXAMPLES

Next, specific numerical examples of the imaging lens according to the present embodiment will be described.

Here, the meanings and the like of symbols shown in each of the following tables and descriptions are as below. “Face No.” indicates the number of the ith face to which a symbol is given so that the number increases in order toward the image side with the face of the constituent element furthest to the object side as the first. “Ri” indicates the curvature radius (mm) of the ith face. “Di” indicates the interval (mm) between the ith face and the i+1st face on the optical axis. “Ndi” indicates the value of the refractive index of the d line (wavelength 587.6 nm) of the material (medium) of an optical component with the ith face. “υdi” indicates the value of the Abbe number of the material of the optical component with the ith face on the d line. Further, Fno indicates the F number, f indicates the focus distance of the entire system, ω indicates the half angle, and β indicates the capturing magnification (lateral magnification).

The imaging lenses 1 to 8 according to each numerical example below are all configured by the aperture stop St, the front group Gf arranged further to the object side than the aperture stop St, and the rear group Gr arranged further to the image side than the aperture stop St. Further, blurring correction on the image face is performed by moving a lens with a positive refractive force arranged next to the aperture stop St as the blurring correction lens GS in a direction that is different from the optical axis (substantially perpendicular direction). Further, each of the imaging lenses 1 to 8 includes the lens group GrA with a positive refractive force arranged next to the blurring correction lens GS on the image side, the lens group GrB with a negative refractive force arranged next to the lens group GrA on the image side, and the lens group GrC with a positive refractive force on the image side of the lens GrB. The blurring correction lens GS, the lens group GrA, and the lens group GrB are respectively configured by one or two lenses. Focusing is performed by moving the lens group GrA or the lens group GrB as the focus lens group in the optical axis direction.

### Numerical Example 1

Tables 1 and 2 show specific lens data corresponding to the imaging lens 1 according to the first configuration example illustrated in FIG. 1. In particular, the basic lens data is shown in Table 1, and other data is shown in Table 2. In the imaging lens 1, since the lens group GrB moves as the focus lens group, the value of the interval between the faces in front and behind the lens group GrB is variable. The values of the variable face interval during unlimited focusing and limited distance focusing is shown in Table 2 along with the values of Fno, f, ω, and β.

In the imaging lens 1, the front group Gf is configured in order from the object side by a biconvex lens, a positive meniscus lens in which the convex face faces the object side, a negative meniscus lens in which the convex face faces the object side, a biconcave lens, and a biconvex lens. The biconvex lens furthest to the image side within the front group Gf is the blurring correction lens GS. The lens group GrA is configured by a cemented lens formed of a negative meniscus lens in which the convex face faces the object side and a biconvex lens. The lens group GrB is configured by a biconvex lens. The lens group GrC is configured by a biconvex lens and a negative meniscus lens in which the concave face faces the object side.

TABLE 1
EMBODIMENT 1

| LENS GROUP | FACE No. | Ri | Di | Ndi | νdi |
|---|---|---|---|---|---|
| Gf | 1 | 43.670 | 4.572 | 1.834810 | 42.7 |
| | 2 | −750.952 | 0.200 | | |
| | 3 | 29.416 | 3.108 | 1.834810 | 42.7 |
| | 4 | 55.387 | 1.100 | | |
| | 5 | 150.335 | 1.400 | 1.620040 | 36.3 |
| | 6 | 24.675 | 3.944 | | |
| | 7 | −105.384 | 1.000 | 1.647690 | 33.8 |
| | 8 | 21.851 | 2.918 | | |
| | 9 | 66.791 | 2.017 | 1.696802 | 55.5 |
| | 10 | −195.149 | 3.500 | | |
| | 11 (STO) | ∞ | 1.500 | | |
| Gr | 12 | 25.209 | 1.000 | 1.805181 | 25.5 |
| | 13 | 17.940 | 4.304 | 1.729160 | 54.7 |
| | 14 | −96.403 | D14 | | |
| | 15 | −183.662 | 0.900 | 1.568829 | 56.0 |
| | 16 | 18.089 | D16 | | |
| | 17 | 51.641 | 6.944 | 1.729160 | 54.7 |
| | 18 | −30.006 | 6.456 | | |
| | 19 | −26.506 | 1.100 | 1.620040 | 36.3 |
| | 20 | −75.188 | 0.000 | | |

TABLE 2
EMBODIMENT 1

| | UNLIMITED FOCUSING | LIMITED DISTANCE FOCUSING |
|---|---|---|
| Fno | 1.86 | — |
| f | 49.67 | — |
| ω | 16.43 | — |
| β | 0.000 | −0.025 |
| D14 | 1.000 | 1.712 |
| D16 | 12.537 | 11.825 |

### Numerical Example 2

Tables 3 and 4 show specific lens data corresponding to the imaging lens 2 according to the second configuration example illustrated in FIG. 2. In particular, the basic lens data is shown in Table 3, and other data is shown in Table 4. In the imaging lens 2, since the lens group GrB moves as the focus lens group, the value of the interval between the faces in front and behind the lens group GrB is variable. The values of the variable face interval during unlimited focusing and limited distance focusing is shown in Table 4 along with the values of Fno, f, ω, and β.

In the imaging lens 2, the front group Gf is configured in order from the object side by a biconvex lens, a positive meniscus lens in which the convex face faces the object side, a negative meniscus lens in which the convex face faces the object side, a biconcave lens, and a biconvex lens. The biconvex lens furthest to the image side within the front group Gf is the blurring correction lens GS. The lens group GrA is configured by a cemented lens formed of a negative meniscus lens in which the convex face faces the object side and a biconvex lens. The lens group GrB is configured by a biconcave lens. The lens group GrC is configured by a biconvex lens and a negative meniscus lens in which the concave face faces the object side.

TABLE 3
EMBODIMENT 2

| LENS GROUP | FACE No. | Ri | Di | Ndi | νdi |
|---|---|---|---|---|---|
| Gf | 1 | 65.253 | 3.398 | 1.834810 | 42.7 |
| | 2 | −177.349 | 0.200 | | |
| | 3 | 28.605 | 2.760 | 1.834810 | 42.7 |
| | 4 | 52.698 | 1.274 | | |
| | 5 | 434.319 | 1.500 | 1.548140 | 45.8 |
| | 6 | 24.818 | 3.987 | | |
| | 7 | −54.606 | 1.000 | 1.603420 | 38.0 |
| | 8 | 21.980 | 2.799 | | |
| | 9 | 75.706 | 1.813 | 1.696802 | 55.5 |
| | 10 | −85.904 | 2.000 | | |
| | 11 (STO) | ∞ | 1.500 | | |
| Gr | 12 | 23.505 | 0.800 | 1.805181 | 25.5 |
| | 13 | 13.813 | 4.508 | 1.729160 | 54.7 |
| | 14 | −67.880 | D14 | | |
| | 15 | −142.530 | 0.700 | 1.496997 | 81.6 |
| | 16 | 16.922 | D16 | | |
| | 17 | 57.798 | 6.751 | 1.804200 | 46.5 |
| | 18 | −29.570 | 5.706 | | |
| | 19 | −25.972 | 1.000 | 1.846663 | 23.8 |
| | 20 | −56.118 | 0.000 | | |

TABLE 4
EMBODIMENT 2

| | UNLIMITED FOCUSING | LIMITED DISTANCE FOCUSING |
|---|---|---|
| Fno | 1.85 | — |
| f | 41.2 | — |
| ω | 19.27 | — |
| β | 0.000 | −0.025 |
| D14 | 1.000 | 1.681 |
| D16 | 12.612 | 11.931 |

### Numerical Example 3

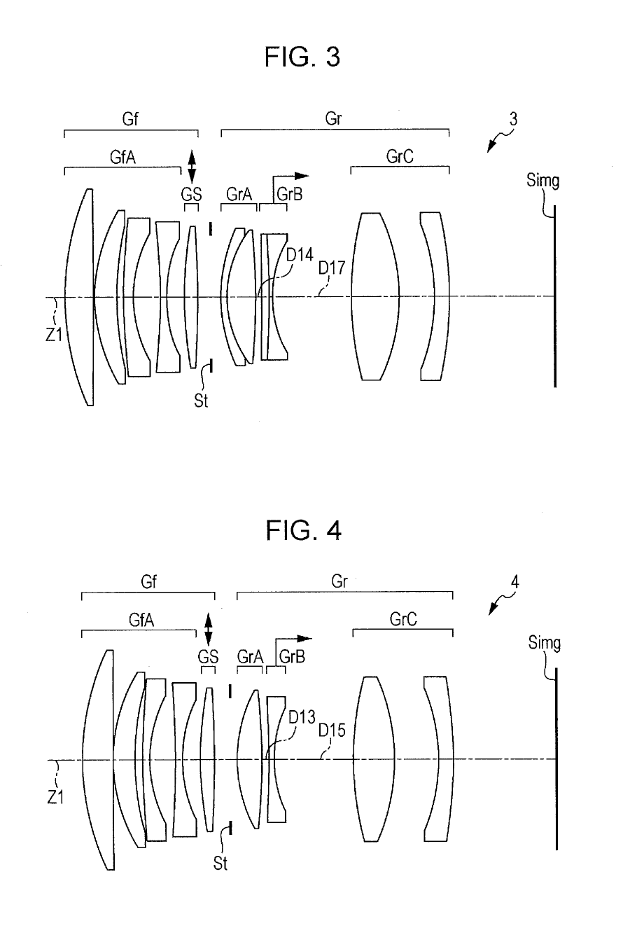

Tables 5 and 6 show specific lens data corresponding to the imaging lens 3 according to the third configuration example illustrated in FIG. 3. In particular, the basic lens data is shown in Table 5, and other data is shown in Table 6. In the imaging lens 3, since the lens group GrB moves as the focus lens group, the value of the interval between the faces in front and behind the lens group GrB is variable. The values of the variable face interval during unlimited focusing and limited distance focusing is shown in Table 6 along with the values of Fno, f, ω, and β.

In the imaging lens 3, the front group Gf is configured in order from the object side by a biconvex lens, a positive meniscus lens in which the convex face faces the object side, a negative meniscus lens in which the convex face faces the object side, a biconcave lens, and a biconvex lens. The biconvex lens furthest to the image side within the front group Gf is the blurring correction lens GS. The lens group GrA is configured by a cemented lens formed of a negative meniscus lens in which the convex face faces the object side and a biconvex lens. The lens group GrB is configured by a cemented lens formed of a positive meniscus lens in which the concave face faces the object side and a biconcave lens. The lens group GrC is configured by a biconvex lens and a negative meniscus lens in which the concave face faces the object side.

TABLE 5
EMBODIMENT 3

| LENS GROUP | FACE No. | Ri | Di | Ndi | νdi |
|---|---|---|---|---|---|
| Gf | 1 | 46.920 | 4.378 | 1.834810 | 42.7 |
| | 2 | −517.474 | 0.200 | | |
| | 3 | 25.746 | 3.517 | 1.834810 | 42.7 |
| | 4 | 52.673 | 1.100 | | |
| | 5 | 123.619 | 1.400 | 1.620040 | 36.3 |
| | 6 | 19.529 | 4.449 | | |
| | 7 | −74.531 | 1.000 | 1.647690 | 33.8 |
| | 8 | 23.422 | 2.891 | | |
| | 9 | 82.806 | 2.016 | 1.729160 | 54.7 |
| | 10 | −128.331 | 2.128 | | |
| | 11 (STO) | ∞ | 1.500 | | |
| Gr | 12 | 25.823 | 1.000 | 1.846663 | 23.8 |
| | 13 | 17.373 | 4.626 | 1.772500 | 49.6 |
| | 14 | −87.704 | D14 | | |
| | 15 | −353.462 | 1.204 | 1.755200 | 27.5 |
| | 16 | −120.000 | 0.500 | 1.638542 | 55.4 |
| | 17 | 18.383 | D17 | | |
| | 18 | 55.576 | 7.500 | 1.729160 | 54.7 |
| | 19 | −30.306 | 5.695 | | |
| | 20 | −30.400 | 2.381 | 1.688930 | 31.2 |
| | 21 | −63.522 | 0.000 | | |

TABLE 6
EMBODIMENT 3

| | UNLIMITED FOCUSING | LIMITED DISTANCE FOCUSING |
|---|---|---|
| Fno | 1.86 | — |
| f | 49.67 | — |
| ω | 16.08 | — |
| β | 0.000 | −0.025 |
| D14 | 0.900 | 1.586 |
| D17 | 12.512 | 11.825 |

### Numerical Example 4

Tables 7 and 8 show specific lens data corresponding to the imaging lens 4 according to the fourth configuration example illustrated in FIG. 4. In particular, the basic lens data is shown in Table 7, and other data is shown in Table 8. In the imaging lens 4, since the lens group GrB moves as the focus lens group, the value of the interval between the faces in front and behind the lens group GrB is variable. The values of the variable face interval during unlimited focusing and limited distance focusing is shown in Table 8 along with the values of Fno, f, ω, and β.

In the imaging lens 4, the front group Gf is configured in order from the object side by a positive meniscus lens in which the convex face faces the object side, a positive meniscus lens in which the convex face faces the object side, a negative meniscus lens in which the convex face faces the object side, a biconcave lens, and a biconvex lens. The biconvex lens furthest to the image side within the front group Gf is the blurring correction lens GS. The lens group GrA is configured by a biconvex lens. The lens group GrB is configured by a biconcave lens. The lens group GrC is configured by a biconvex lens and a negative meniscus lens in which the concave face faces the object side.

TABLE 7
EMBODIMENT 4

| LENS GROUP | FACE No. | Ri | Di | Ndi | νdi |
|---|---|---|---|---|---|
| Gf | 1 | 38.631 | 4.927 | 1.834810 | 42.7 |
| | 2 | 2101.941 | 0.200 | | |
| | 3 | 26.601 | 3.458 | 1.834810 | 42.7 |
| | 4 | 52.523 | 1.100 | | |
| | 5 | 113.544 | 1.100 | 1.688930 | 31.2 |
| | 6 | 21.682 | 4.178 | | |
| | 7 | −119.739 | 1.000 | 1.672700 | 32.2 |
| | 8 | 21.755 | 2.967 | | |
| | 9 | 65.097 | 2.133 | 1.729160 | 54.7 |
| | 10 | −164.076 | 2.500 | | |
| | 11 (STO) | ∞ | 1.200 | | |
| Gr | 12 | 22.970 | 3.854 | 1.603001 | 65.4 |
| | 13 | −98.163 | D13 | | |
| | 14 | −198.109 | 0.900 | 1.568829 | 56.0 |
| | 15 | 18.389 | D15 | | |
| | 16 | 52.301 | 6.507 | 1.729160 | 54.7 |
| | 17 | −31.190 | 7.053 | | |
| | 18 | −28.787 | 2.403 | 1.688930 | 31.2 |
| | 19 | −74.145 | 0.000 | | |

TABLE 8
EMBODIMENT 4

| | UNLIMITED FOCUSING | LIMITED DISTANCE FOCUSING |
|---|---|---|
| Fno | 1.86 | — |
| f | 51.50 | — |
| ω | 15.56 | — |
| β | 0.000 | −0.025 |
| D13 | 1.000 | 1.756 |
| D15 | 12.555 | 11.800 |

### Numerical Example 5

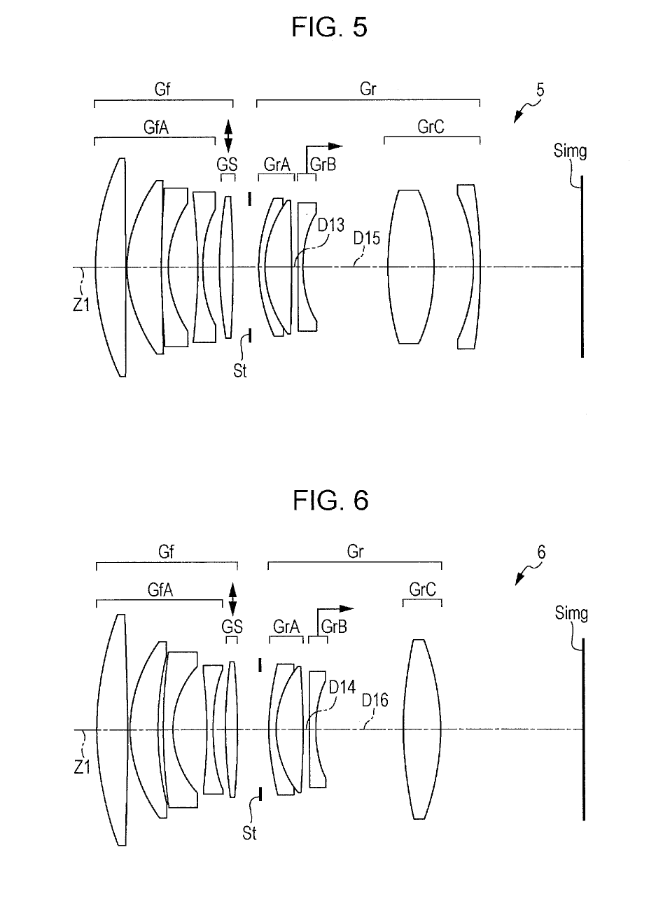

Tables 9 and 10 show specific lens data corresponding to the imaging lens 5 according to the fifth configuration example illustrated in FIG. 5. In particular, the basic lens data is shown in Table 9, and other data is shown in Table 10. In the imaging lens 5, since the lens group GrB moves as the focus lens group, the value of the interval between the faces in front and behind the lens group GrB is variable. The values of the variable face interval during unlimited focusing and limited distance focusing is shown in Table 10 along with the values of Fno, f, ω, and β.

In the imaging lens 5, the front group Gf is configured in order from the object side by a positive meniscus lens in which the convex face faces the object side, a cemented lens formed of a positive meniscus lens in which the convex face faces the object side and a negative meniscus lens in which the convex face faces the object side, a biconcave lens, and a biconvex lens. The biconvex lens furthest to the image side within the front group Gf is the blurring correction lens GS. The lens group GrA is configured by a cemented lens formed of a negative meniscus lens in which the convex face faces the object side and a biconvex lens. The lens group GrB is configured by a biconcave lens. The lens group GrC is configured by a biconvex lens and a negative meniscus lens in which the concave face faces the object side.

TABLE 9
EMBODIMENT 5

| LENS GROUP | FACE No. | Ri | Di | Ndi | νdi |
|---|---|---|---|---|---|
| Gf | 1 | 40.610 | 4.709 | 1.834810 | 42.7 |
| | 2 | 701.302 | 0.400 | | |
| | 3 | 22.808 | 5.420 | 1.723417 | 38.0 |
| | 4 | 206.085 | 1.100 | 1.903658 | 3.1 |
| | 5 | 19.438 | 4.618 | | |
| | 6 | −73.920 | 0.800 | 1.647690 | 33.8 |
| | 7 | 23.777 | 2.688 | | |
| | 8 | 67.011 | 1.969 | 1.772500 | 49.6 |
| | 9 | −240.237 | 2.700 | | |
| | 10 (STO) | ∞ | 1.500 | | |
| Gr | 11 | 27.246 | 1.000 | 1.846663 | 23.8 |
| | 12 | 17.913 | 4.172 | 1.804200 | 46.5 |
| | 13 | −171.244 | D13 | | |
| | 14 | −208.271 | 0.700 | 1.487489 | 70.4 |
| | 15 | 18.350 | D15 | | |
| | 16 | 50.166 | 7.000 | 1.729160 | 54.7 |
| | 17 | −31.925 | 6.298 | | |
| | 18 | −28.458 | 1.100 | 1.717360 | 29.5 |
| | 19 | −76.772 | 0.000 | | |

TABLE 10
EMBODIMENT 5

| | UNLIMITED FOCUSING | LIMITED DISTANCE FOCUSING |
|---|---|---|
| Fno | 1.85 | — |
| f | 50.99 | — |
| ω | 15.78 | — |
| β | 0.000 | −0.025 |
| D13 | 1.000 | 1.915 |
| D15 | 13.626 | 12.711 |

### Numerical Example 6

Tables 11 and 12 show specific lens data corresponding to the imaging lens 6 according to the sixth configuration example illustrated in FIG. 6. In particular, the basic lens data is shown in Table 11, and other data is shown in Table 12. In the imaging lens 6, since the lens group GrB moves as the focus lens group, the value of the interval between the faces in front and behind the lens group GrB is variable. The values of the variable face interval during unlimited focusing and limited distance focusing is shown in Table 12 along with the values of Fno, f, ω, and β.

In the imaging lens 6, the front group Gf is configured in order from the object side by a biconvex lens, a positive meniscus lens in which the convex face faces the object side, a negative meniscus lens in which the convex face faces the object side, a biconcave lens, and a biconvex lens. The biconvex lens furthest to the image side within the front group Gf is the blurring correction lens GS. The lens group GrA is configured by a cemented lens formed of a negative meniscus lens in which the convex face faces the object side and a biconvex lens. The lens group GrB is configured by a biconcave lens. The lens group GrC is configured by a biconvex lens.

TABLE 11
EMBODIMENT 6

| LENS GROUP | FACE No. | Ri | Di | Ndi | νdi |
|---|---|---|---|---|---|
| Gf | 1 | 53.440 | 4.985 | 1.834810 | 42.7 |
| | 2 | −320.194 | 0.200 | | |
| | 3 | 22.891 | 4.500 | 1.834810 | 42.7 |
| | 4 | 52.067 | 1.100 | | |
| | 5 | 134.965 | 1.400 | 1.595510 | 39.2 |
| | 6 | 15.179 | 5.224 | | |
| | 7 | −79.347 | 1.000 | 1.784719 | 25.7 |
| | 8 | 31.119 | 2.104 | | |
| | 9 | 84.684 | 1.753 | 1.910822 | 0.4 |
| | 10 | −124.721 | 3.500 | | |
| | 11 (STO) | ∞ | 1.500 | | |
| Gr | 12 | 41.457 | 1.000 | 1.752110 | 25.0 |
| | 13 | 15.591 | 4.393 | 1.883000 | 40.8 |
| | 14 | −93.123 | D14 | | |
| | 15 | 16211.320 | 0.900 | 1.696802 | 55.5 |
| | 16 | 19.576 | D16 | | |
| | 17 | 68.742 | 5.829 | 1.729160 | 54.7 |
| | 18 | −38.643 | 0.000 | | |

TABLE 12
EMBODIMENT 6

| | UNLIMITED FOCUSING | LIMITED DISTANCE FOCUSING |
|---|---|---|
| Fno | 1.85 | — |
| f | 50.43 | — |
| ω | 15.70 | — |
| β | 0.000 | −0.025 |
| D14 | 1.000 | 1.745 |
| D16 | 13.982 | 13.237 |

### Numerical Example 7

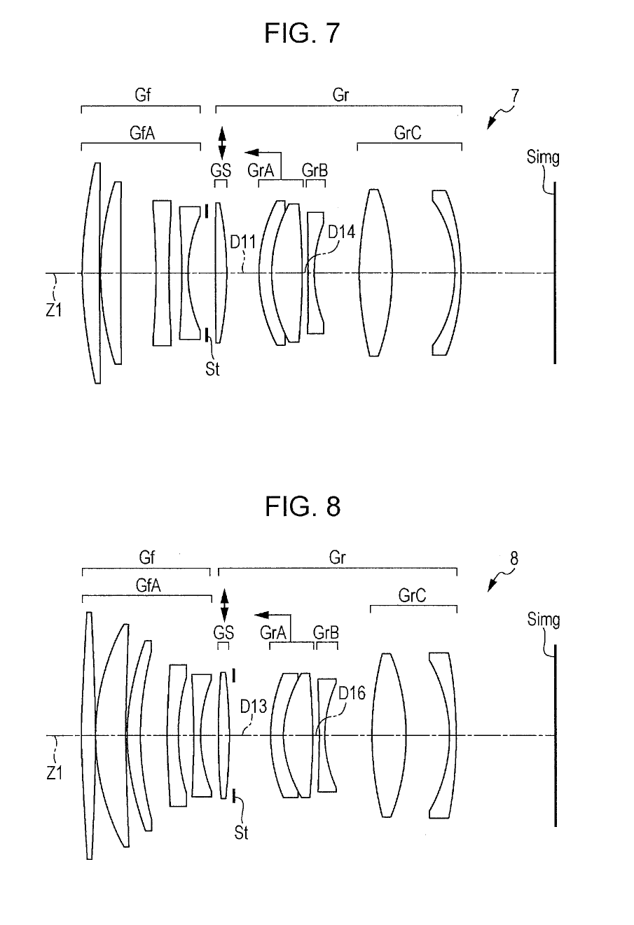

Tables 13 and 14 show specific lens data corresponding to the imaging lens 7 according to the seventh configuration example illustrated in FIG. 7. In particular, the basic lens data is shown in Table 13, and other data is shown in Table 14. In the imaging lens 7, since the lens group GrA moves as the focus lens group, the value of the interval between the faces in front and behind the lens group GrA is variable. The values of the variable face interval during unlimited focusing and limited distance focusing is shown in Table 14 along with the values of Fno, f, ω, and β.

In the imaging lens 7, the front group Gf is configured in order from the object side by a positive meniscus lens in which the convex face faces the object side, a positive meniscus lens in which the convex face faces the object side, a biconcave lens, and a biconcave lens. A positive meniscus lens in which the concave face faces the object side is arranged furthest to the object side within the rear group Gr, and the positive meniscus lens is the blurring correction lens GS. The lens group GrA is configured by a cemented lens formed of a negative meniscus lens in which the convex face faces the object side and a biconvex lens. The lens group GrB is configured by a biconcave lens. The lens group GrC is configured by a biconvex lens and a negative meniscus lens in which the concave face faces the object side.

TABLE 13
EMBODIMENT 7

| LENS GROUP | FACE No. | Ri | Di | Ndi | νdi |
|---|---|---|---|---|---|
| Gf | 1 | 80.985 | 2.580 | 1.834810 | 42.7 |
| | 2 | 960.860 | 0.200 | | |
| | 3 | 48.319 | 3.136 | 1.903658 | 3.1 |
| | 4 | 510.990 | 5.705 | | |
| | 5 | −101.542 | 1.800 | 1.672700 | 32.2 |
| | 6 | 96.008 | 2.237 | | |
| | 7 | −115.990 | 1.000 | 1.761818 | 2.7 |
| | 8 | 25.029 | 2.862 | | |
| | 9 (STO) | ∞ | 1.500 | | |
| Gr | 10 | −805.205 | 1.724 | 1.804200 | 46.5 |
| | 11 | −56.165 | D11 | | |
| | 12 | 24.100 | 2.000 | 1.846663 | 23.8 |
| | 13 | 23.270 | 5.000 | 1.729160 | 54.7 |
| | 14 | −103.149 | D14 | | |
| | 15 | −185.335 | 1.000 | 1.846663 | 23.8 |
| | 16 | 24.689 | 7.059 | | |
| | 17 | 54.314 | 5.149 | 1.903658 | 3.1 |
| | 18 | −39.670 | 9.924 | | |
| | 19 | −20.089 | 1.000 | 1.696802 | 55.5 |
| | 20 | −35.771 | 0.000 | | |

TABLE 14
EMBODIMENT 7

| | UNLIMITED FOCUSING | LIMITED DISTANCE FOCUSING |
|---|---|---|
| Fno | 1.95 | — |
| f | 46.42 | — |
| ω | 16.70 | — |
| β | 0.000 | −0.025 |
| D11 | 5.123 | 4.665 |
| D14 | 1 | 1.458 |

### Numerical Example 8

Tables 15 and 16 show specific lens data corresponding to the imaging lens 8 according to the eighth configuration example illustrated in FIG. 8. In particular, the basic lens data is shown in Table 15, and other data is shown in Table 16. In the imaging lens 8, since the lens group GrA moves as the focus lens group, the value of the interval between the faces in front and behind the lens group GrA is variable. The values of the variable face interval during unlimited focusing and limited distance focusing is shown in Table 16 along with the values of Fno, f, ω, and β.

In the imaging lens 8, the front group Gf is configured in order from the object side by a biconvex lens, a positive meniscus lens in which the convex face faces the object side, a positive meniscus lens in which the convex face faces the object side, a negative meniscus lens in which the convex face faces the object side, a biconcave lens, and a biconvex lens. The biconvex lens furthest to the image side within the front group Gf is the blurring correction lens GS. The lens group GrA is configured by a cemented lens formed of a negative meniscus lens in which the convex face faces the object side and a biconvex lens. The lens group GrB is configured by a biconcave lens. The lens group GrC is configured by a biconvex lens and a negative meniscus lens in which the concave face faces the object side.

TABLE 15
EMBODIMENT 8

| LENS GROUP | FACE No. | Ri | Di | Ndi | νdi |
|---|---|---|---|---|---|
| Gf | 1 | 261.047 | 2.000 | 1.487489 | 70.4 |
| | 2 | −315.449 | 0.200 | | |
| | 3 | 36.783 | 4.752 | 1.834001 | 37.3 |
| | 4 | 285.932 | 0.200 | | |
| | 5 | 40.323 | 2.052 | 1.922860 | 20.9 |
| | 6 | 53.485 | 4.217 | | |
| | 7 | 152.972 | 1.800 | 1.784719 | 25.7 |
| | 8 | 36.259 | 2.537 | | |
| | 9 | −92.455 | 1.000 | 1.740770 | 27.8 |
| | 10 | 23.324 | 2.780 | | |
| | 11 | 99.514 | 1.766 | 1.696802 | 55.5 |
| | 12 | −86.614 | 0.789 | | |
| | 13 (STO) | ∞ | D13 | | |
| Gr | 14 | 23.186 | 2.125 | 1.805181 | 25.5 |
| | 15 | 17.746 | 4.661 | 1.696802 | 55.5 |
| | 16 | −98.097 | D16 | | |
| | 17 | −148.928 | 1.000 | 1.761818 | 2.7 |
| | 18 | 22.016 | 7.457 | | |
| | 19 | 52.605 | 5.377 | 1.903658 | 3.1 |
| | 20 | −36.144 | 6.848 | | |
| | 21 | −23.786 | 1.000 | 1.487489 | 70.4 |
| | 22 | −73.296 | 0.000 | | |

TABLE 16
EMBODIMENT 8

| | UNLIMITED FOCUSING | LIMITED DISTANCE FOCUSING |
|---|---|---|
| Fno | 1.85 | — |
| f | 49.15 | — |
| ω | 15.87 | — |
| β | 0.000 | −0.025 |
| D13 | 5.759 | 4.980 |
| D16 | 1 | 1.778 |

### Other Numerical Data of Each Example

Table 17 shows values relating to each conditional equation described above summarized for each numerical example. As is seen from Table 17, the values of each numerical example are within the numerical value of each conditional equation.

TABLE 17

| CONDITIONAL | EMBODI- | EMBODI- | EMBODI- | EMBODI- | EMBODI- | EMBODI- | | |
|---|---|---|---|---|---|---|---|---|
| EQUATION | MENT 1 | MENT 2 | MENT 3 | MENT 4 | MENT 5 | MENT 6 | EMBODIMENT 7 | EMBODIMENT 8 |
| (1) | −0.415 | −0.643 | −0.483 | −0.401 | −0.503 | −0.397 | −0.523 | −0.444 |
| (2) | 0.041 | 0.049 | 0.039 | 0.037 | 0.060 | 0.048 | 0.001 | 0.003 |
| (3) | 1.477 | 1.408 | 1.395 | 1.246 | 1.334 | 1.103 | 1.616 | 1.357 |
| (4) | 0.373 | 0.411 | 0.370 | 0.357 | 0.360 | 0.386 | 0.532 | 0.448 |
| (5) | 55.460 | 55.460 | 54.674 | 54.674 | 49.624 | 35.250 | 46.503 | 55.460 |

### Aberration Performance

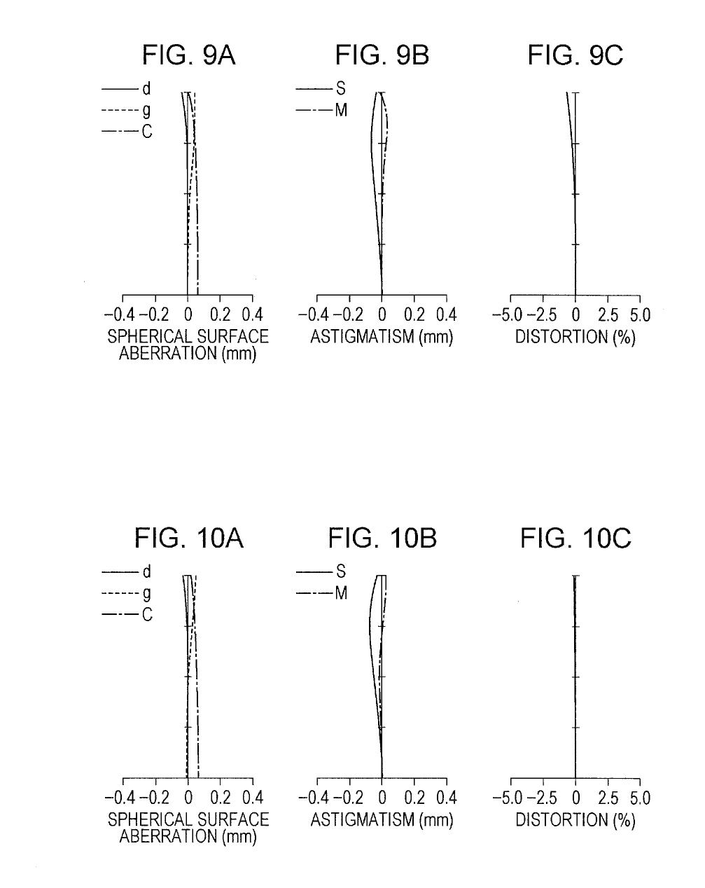

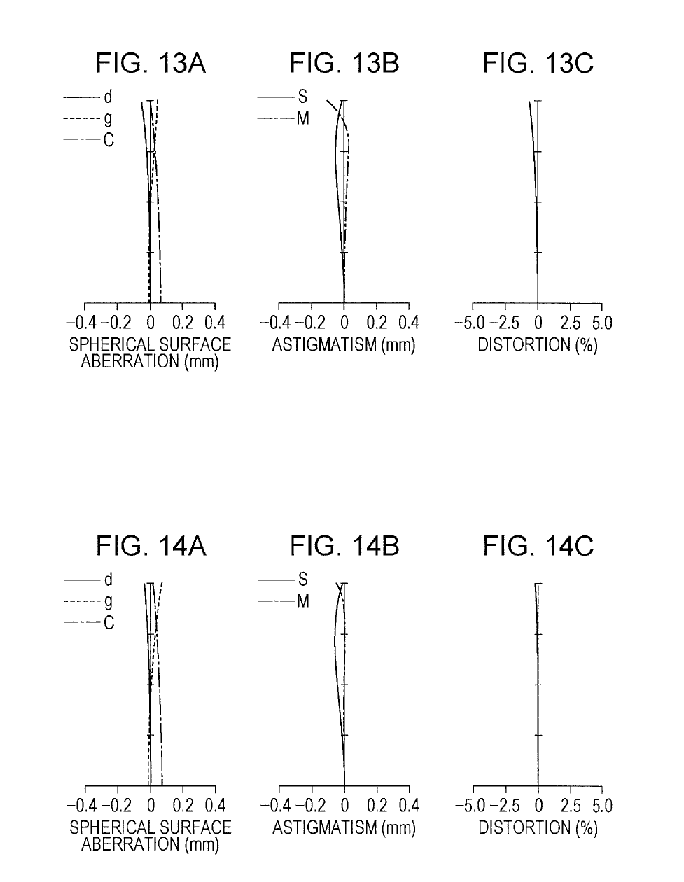

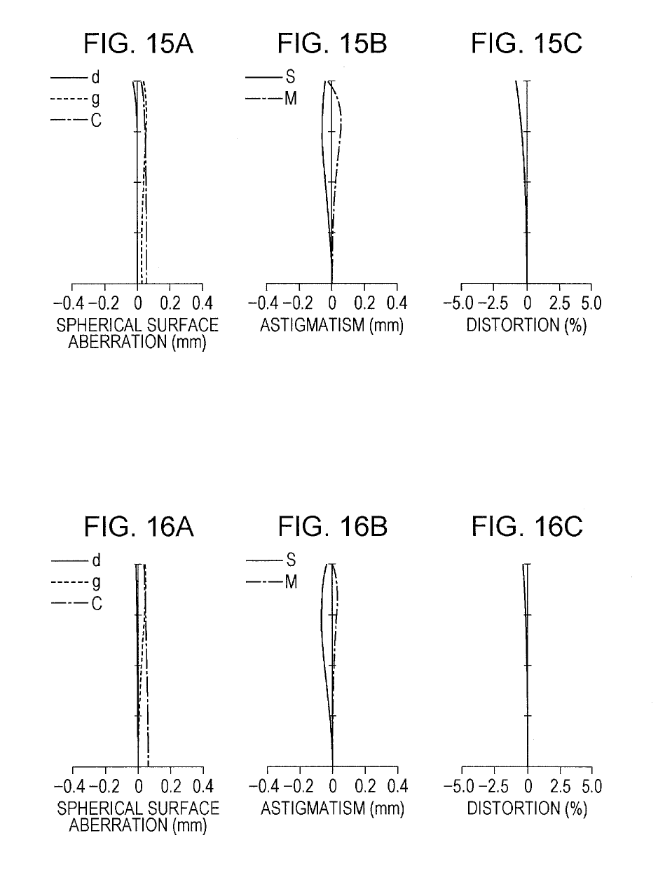

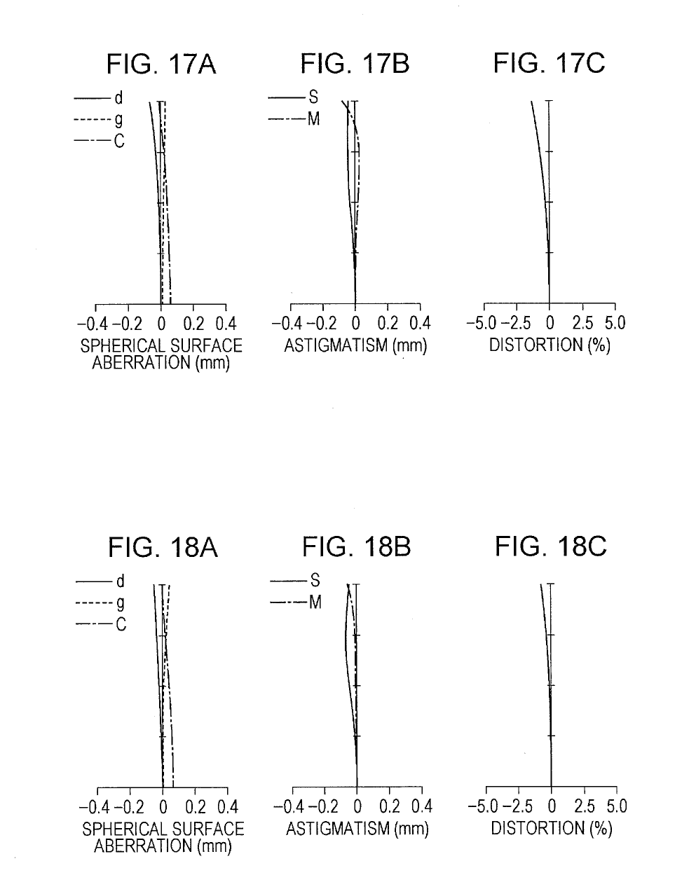

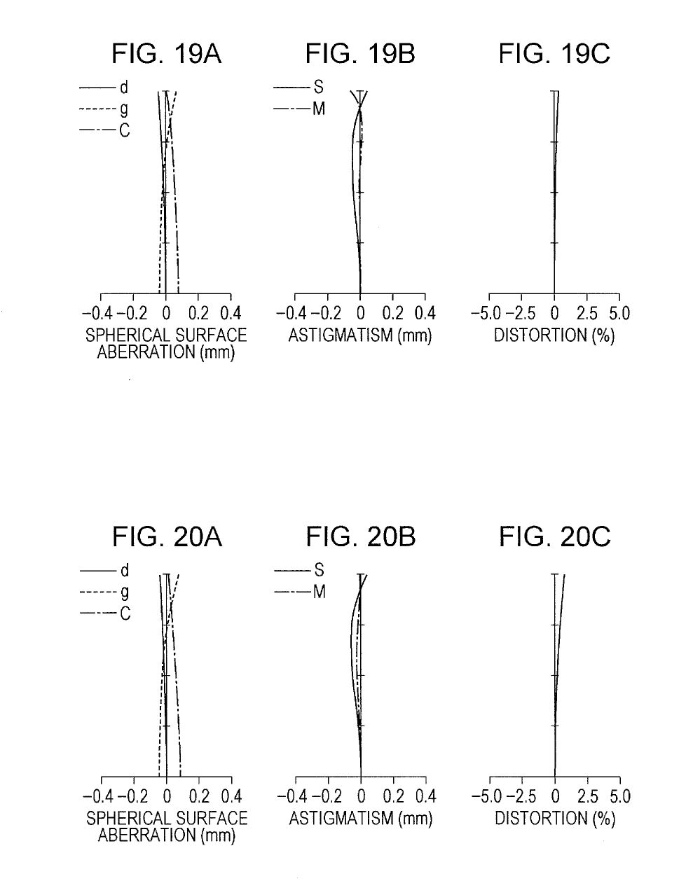

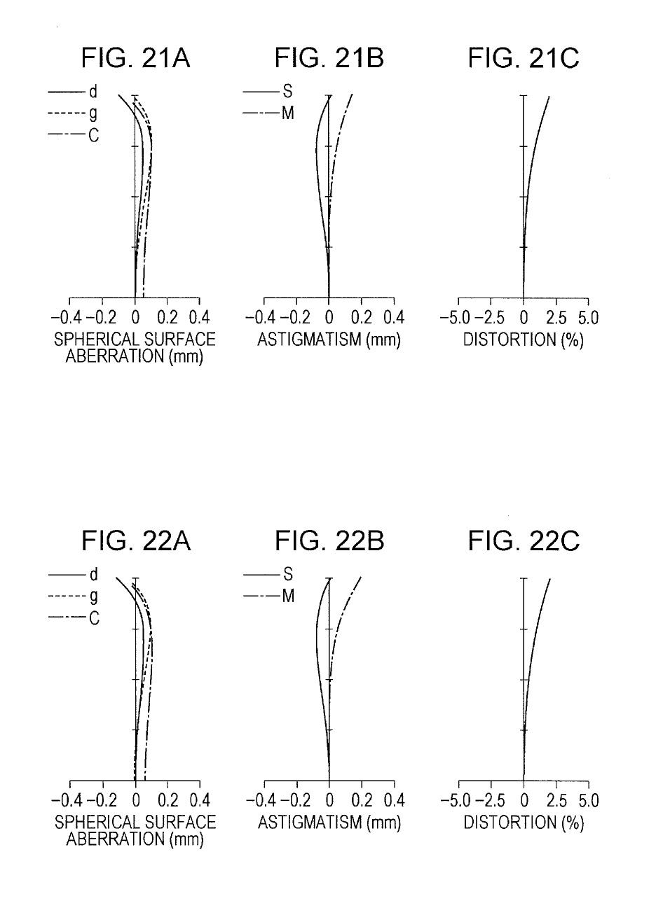

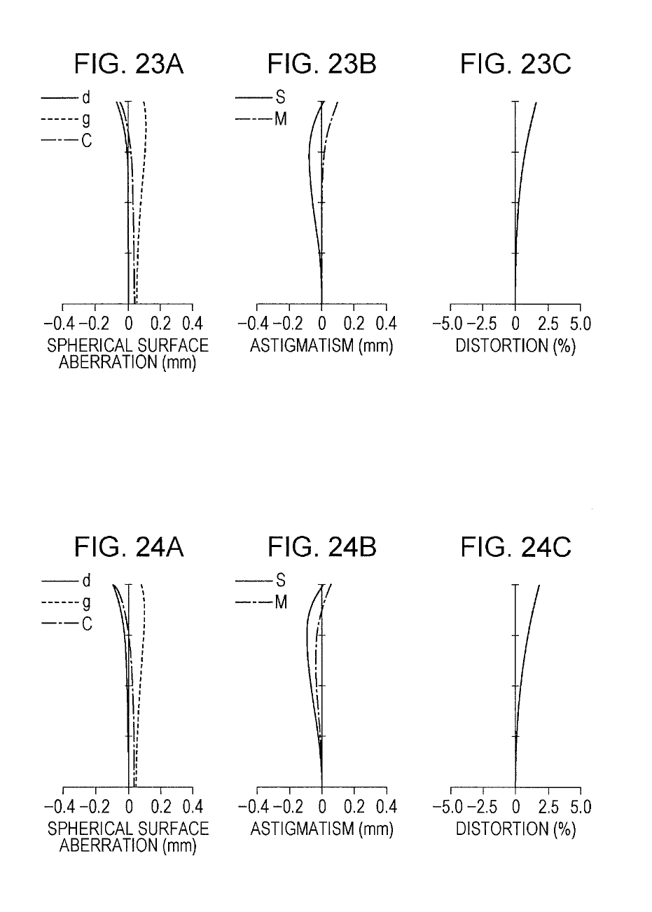

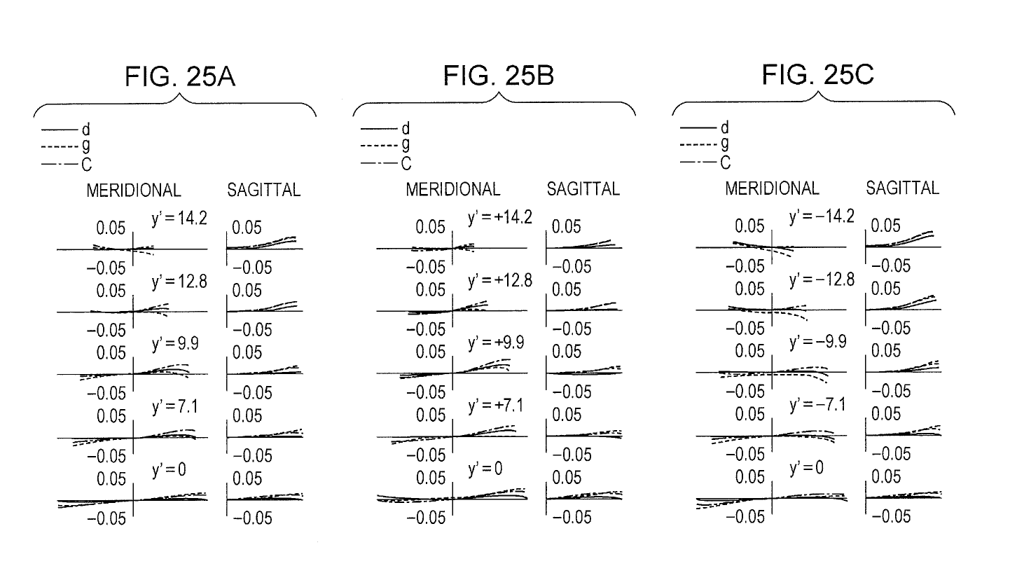

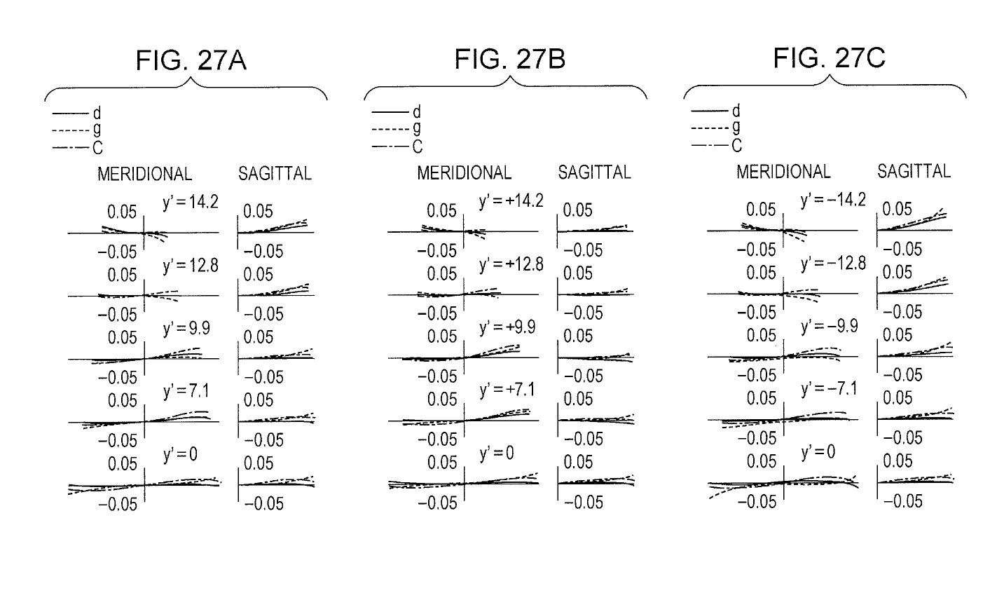

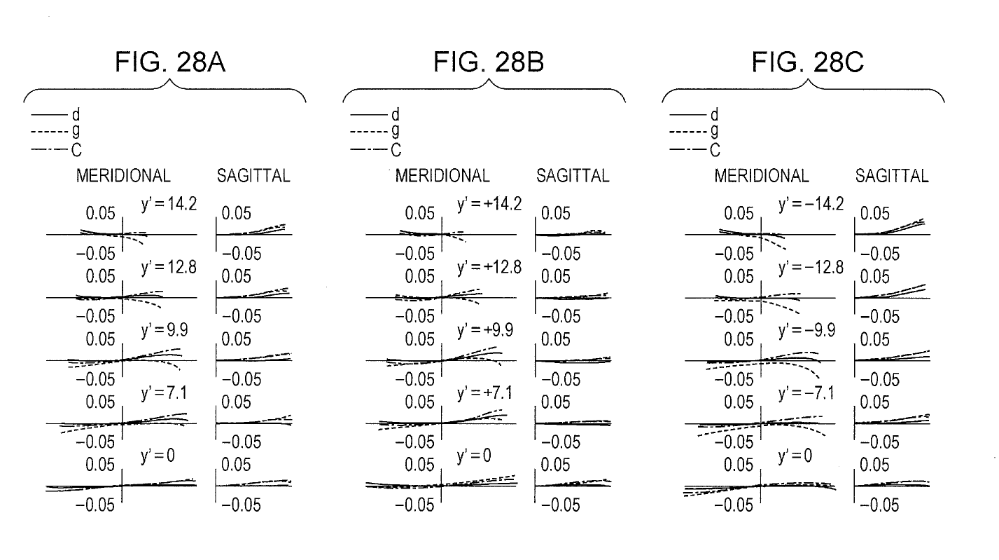

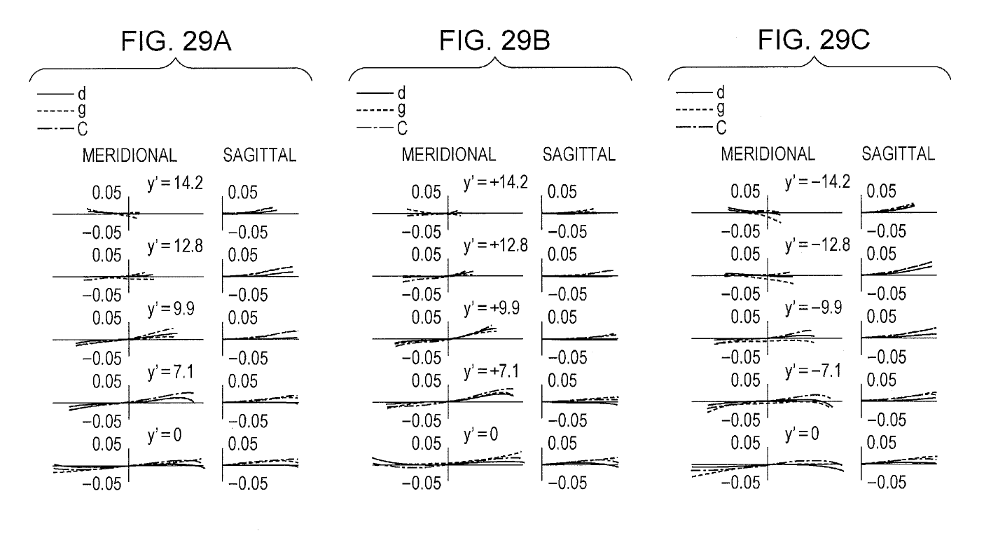

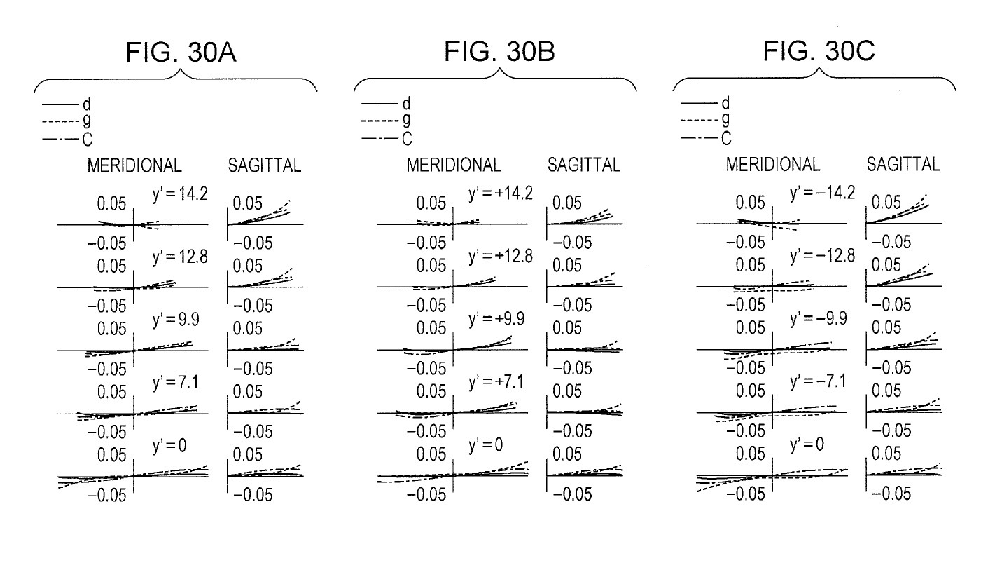

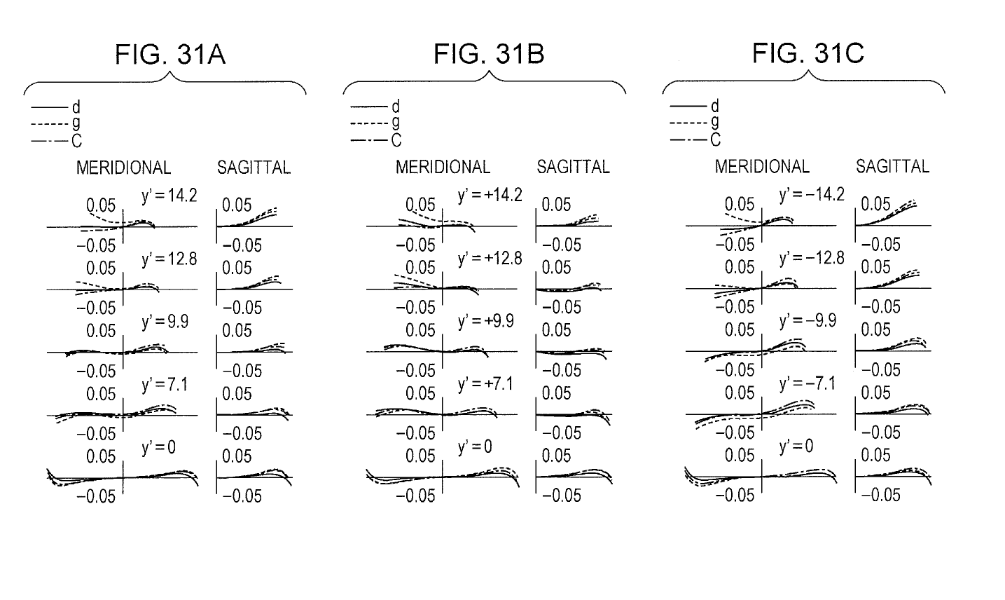

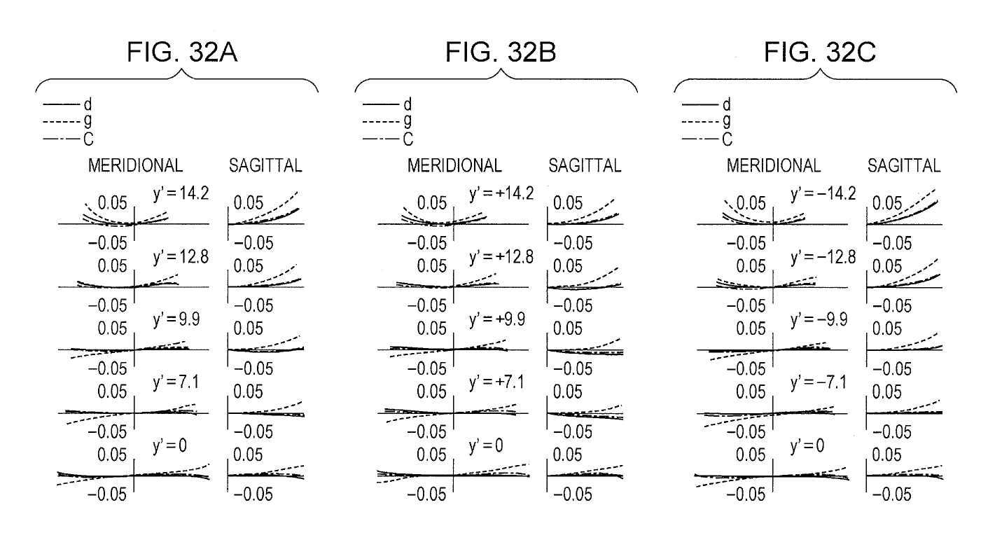

The aberration performance of each numerical example is illustrated in FIGS. 9A to 9C to 32A to 32C. In particular, FIGS. 9A to 9C to 24A to 24C illustrate the longitudinal aberration and FIGS. 25A to 25C and 32A to 32C illustrate the lateral aberration.

FIGS. 9A to 9C respectively illustrate the spherical surface aberration, the astigmatism, and the distortion of the imaging lens 1 corresponding to Numerical Example 1 during unlimited focusing. FIGS. 10A to 10C illustrate each of the same aberrations during limited distance focusing (capturing magnification β=−0.025). In each aberration drawing, aberrations with the d line (587.6 nm) as the standard wavelength are illustrated. In the spherical surface aberration drawings, aberrations for a g line (435.84 nm) and a C line (656.28 nm) are also illustrated. In the astigmatism drawings, S (solid line) indicates an aberration in the sagittal direction and M (single dotted chain line) indicates an aberration in the meridional direction.

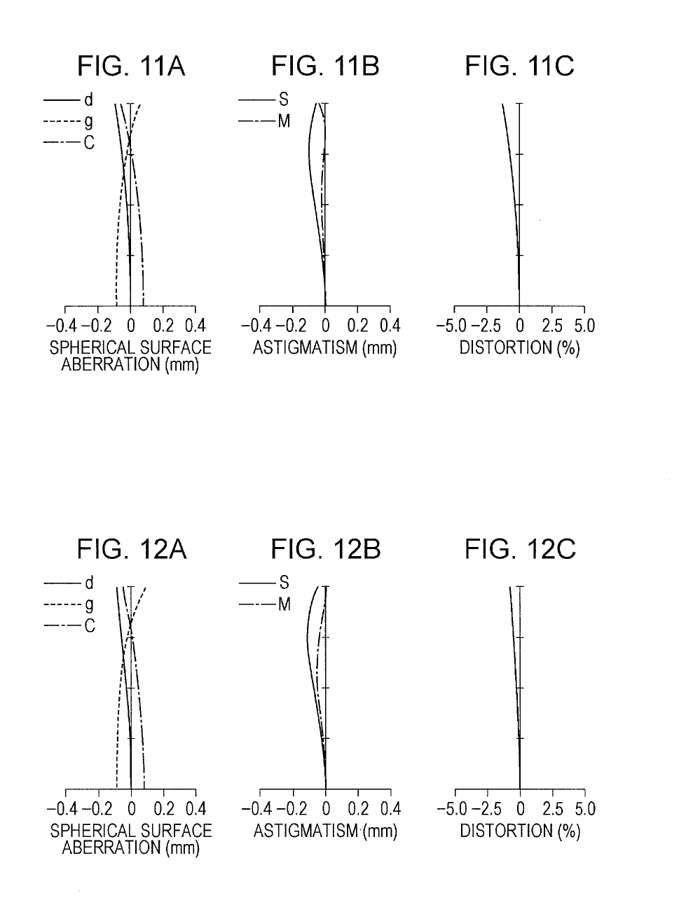

Similarly, the spherical aberration, the astigmatism, and the distortion during unlimited focusing and limited distance focusing for the imaging lenses 2 to 8 corresponding to Numerical Examples 2 to 8 are illustrated in FIGS. 11A to 11C to 24A to 24C.

FIGS. 25A to 25C illustrate the lateral aberration of the imaging lens 1 corresponding to Numerical Example 1 during unlimited focusing. In particular, FIG. 25A illustrates the lateral aberration before image blurring correction, FIG. 25B illustrates the lateral aberration after image blurring correction with an angle of +0.3°, and FIG. 25C illustrates the lateral aberration after image blurring correction with an angle of −0.3°. The aberrations for the g line and the C line with the d line as the standard wavelength are also illustrated in each aberration drawing.

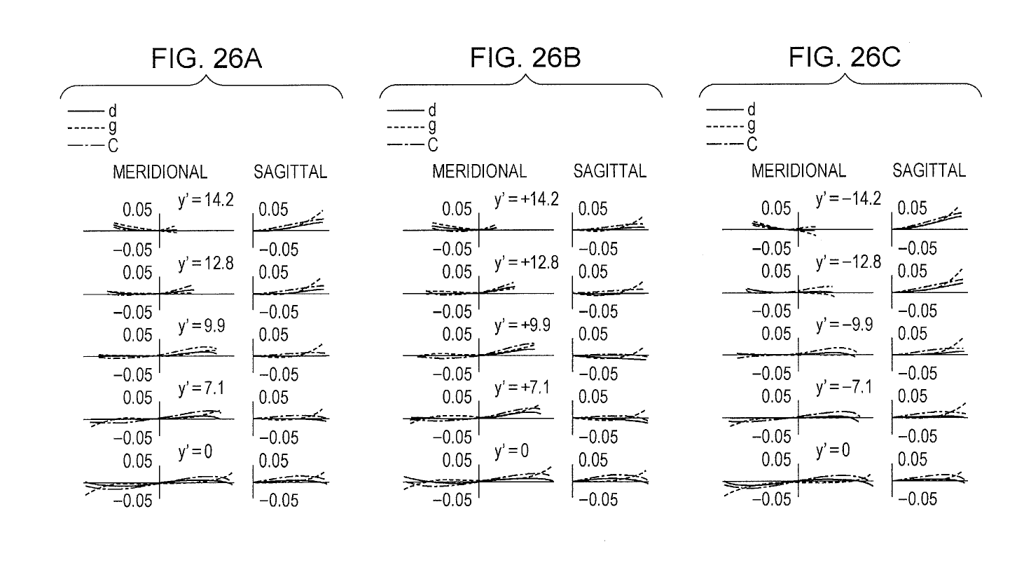

Similarly, the lateral aberration before image blurring correction during unlimited focusing for the imaging lenses 2 to 8 corresponding to Numerical Examples 2 to 8 is illustrated in FIGS. 26A to 32A. Further, the lateral aberration after image blurring correction with an angle of +0.3° is illustrated in FIGS. 26B to 32B. Further, the lateral aberration after image blurring correction with an angle of −0.3° is illustrated in FIGS. 26C to 32C.

As is seen from each aberration drawing, for each example, during both unlimited focusing and limited distance focusing, each aberration is corrected well with good balance and has excellent imaging performance. Further, aberration after the image blurring correction is also favorable.

### Other Embodiments

The technology according to the embodiments of the present disclosure is not limited to the description of the embodiments and examples described above, and various modification examples are possible.

For example, the shapes and numerical values of each portion shown in each numerical example described above are only specific examples for realizing the embodiments of the present technology, and the technical range of the embodiments of the present technology is not to be interpreted as being limited thereby.

Further, while a configuration substantially formed of two lens groups has been described in the embodiments and examples described above, there may be a configuration in which a lens with substantially no refractive force is included.

Further, for example, the present technology is able to be configured as below.

[1]

An imaging lens including: an aperture stop; a front group arranged further to the object side than the aperture stop; and a rear group arranged further to the image side than the aperture stop, wherein image blurring correction on the image face is performed by including a lens with a positive refractive force within the front group or the rear group next to the aperture stop and moving the lens with the positive refractive force as a blurring correction lens in a different direction from the optical axis, the rear group includes a lens group GrA with a positive refractive force arranged next to the blurring correction lens on the image side and a lens group GrB with a negative refractive force arranged next to the lens group GrA on the image side, the blurring correction lens, the lens group GrA, and the lens group GrB are respectively configured by one or two lenses, focusing is performed by moving the lens group GrA performs or the lens group GrB as a focus lens group in the optical axis direction, and each of the following conditional equations are satisfied.

−1.0<f/f1a<0.5 1

(βf+1/βf)⁻²<0.16 2

wherein

f: focus distance of the entire system

f1a: focus distance of a lens group further to the object side than the blurring correction lens

βf: lateral magnification of the focus lens group.

[2]

The imaging lens according to [1], wherein the following equation is satisfied.

0.5<fS/f<2 3

wherein

fS: focus distance of the blurring correction lens.

[3]

The imaging lens according to [1] or [2], wherein the following equation is satisfied.

0.2<rGrB/f<0.9 4

wherein

rGrB: curvature radius of a face of the lens group GrB furthest to the image side.

[4]

The imaging lens according to any one of [1] to [3], wherein the following equation is satisfied.

30.5<υdS 5

wherein

υdS: Abbe number of the blurring correction lens with respect to a d line of the medium.

[5]

The imaging lens according to any one of [1] to [4], wherein the lens group GrA is formed of a cemented lens of a negative lens and a positive lens.

[6]

The imaging lens according to any one of [1] to [5], wherein the rear group further includes a lens group GrC with a positive refractive force arranged on the image side of the lens group GrB.

[7]

The imaging lens according to any one of [1] to [6], further including a lens with substantially no refractive force.

[8]

An imaging device including: an imaging lens; and an imaging element formed of the imaging lens outputting an imaging signal according to an optical image, wherein the imaging lens is configured by an aperture stop, a front group arranged further to an object side than the aperture stop, and a rear group arranged further to an image side than the aperture stop, image blurring correction on the image face is performed by including a lens with a positive refractive force within the front group or the rear group next to the aperture stop and moving the lens with the positive refractive force as a blurring correction lens in a different direction from the optical axis, the rear group includes a lens group GrA with a positive refractive force arranged next to the blurring correction lens on the image side and a lens group GrB with a negative refractive force arranged next to the lens group GrA on the image side, the blurring correction lens, the lens group GrA, and the lens group GrB are respectively configured by one or two lenses, focusing is performed by moving the lens group GrA or the lens group GrB as a focus lens group in the optical axis direction, and each of the following conditional equations are satisfied.

−1.0<f/f1a<0.5 (1)

(βf+1/βf)⁻²<0.16 (2)

wherein

f: focus distance of the entire system

f1a: focus distance of a lens group further to the object side than the blurring correction lens

βf: lateral magnification of the focus lens group.

[9]

The imaging device according to [8], wherein the imaging lens further includes a lens with substantially no refractive force.

The present disclosure contains subject matter related to that disclosed in Japanese Priority Patent Application JP 2011-230923 filed in the Japan Patent Office on Oct. 20, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging lens comprising:
an aperture stop;
a front group arranged further to an object side than the aperture stop; and
a rear group arranged further to the image side than the aperture stop,
wherein image blurring correction on an image face is performed by including a lens with a positive refractive force within the front group or the rear group next to the aperture stop and moving the lens with the positive refractive force as a blurring correction lens in a different direction from an optical axis,
the rear group includes a lens group GrA with a positive refractive force arranged next to the blurring correction lens on the image side and a lens group GrB with a negative refractive force arranged next to the lens group GrA on the image side,
the blurring correction lens, the lens group GrA, and the lens group GrB are respectively configured by one or two lenses,
focusing is performed by moving the lens group GrA or the lens group GrB as a focus lens group in the optical axis direction, and
each of the following conditional equations is satisfied.
−1.0<f/f1a<0.5 (1)
(βf+1/βf)⁻²<0.16 (2)
wherein
f: focus distance of entire system
f1a: focus distance of a lens group further to the object side than the blurring correction lens
βf: lateral magnification of the focus lens group.

2. The imaging lens according to claim 1,
wherein the following equation is satisfied.
0.5<fS/f<2 (3)
wherein
fS: focus distance of the blurring correction lens.

3. The imaging lens according to claim 1,
wherein the following equation is satisfied.
0.2<rGrB/f<0.9 (4)
wherein
rGrB: curvature radius of a face of the lens group GrB furthest to the image side.

4. The imaging lens according to claim 1,
wherein the following equation is satisfied.
30.5<υdS (5)
wherein
υdS: Abbe number of the blurring correction lens with respect to a d line of a medium.

5. The imaging lens according to claim 1,
wherein the lens group GrA is formed of a cemented lens of a negative lens and a positive lens.

6. The imaging lens according to claim 1,
wherein the rear group further includes a lens group GrC with a positive refractive force arranged on the image side of the lens group GrB.

7. An imaging device comprising:
an imaging lens; and
an imaging element formed of the imaging lens outputting an imaging signal according to an optical image,
wherein the imaging lens is configured by an aperture stop, a front group arranged further to an object side than the aperture stop, and a rear group arranged further to an image side than the aperture stop,
image blurring correction on an image face is performed by including a lens with a positive refractive force within the front group or the rear group next to the aperture stop and moving the lens with the positive refractive force as a blurring correction lens in a different direction from an optical axis,
the rear group includes a lens group GrA with a positive refractive force arranged next to the blurring correction lens on the image side and a lens group GrB with a negative refractive force arranged next to the lens group GrA on the image side,
the blurring correction lens, the lens group GrA, and the lens group GrB are respectively configured by one or two lenses,
focusing is performed by moving the lens group GrA or the lens group GrB as a focus lens group in the optical axis direction, and
each of the following conditional equations is satisfied.
−1.0<f/f1a<0.5 (1)
(βf+1/βf)⁻²<0.16 (2)
wherein
f: focus distance of entire system
f1a: focus distance of a lens group further to the object side than the blurring correction lens
βf: lateral magnification of the focus lens group.
